(19) United States
(12) Patent Application Publication
(10) Pub. No.: US 2020/0270826 A1
(43) Pub. Date: Aug. 27, 2020

(54) ROADWAY MARKING EQUIPMENT FIELD PROGRAMMABLE CONTROLLER

(71) Applicant: LimnTech LLC, Souderton, PA (US)

(72) Inventors: Douglas D. Dolinar, Doylestown \, PA (US); William R. Haiier, Bethlehem, PA (US); Kyle Leonard, Philadelphia, PA (US)

(73) Assignee: LimnTech LLC, Souderton, PA (US)

(21) Appl. No.: 16/647,658

(22) PCT Filed: Sep. 24, 2018
(86) PCT No.: PCT/US18/52395

§ 371 Date: Mar. 16, 2020

Related U.S. Application Data
(60) Provisional application No. 62/562,685, filed on Sep. 25, 2017.

(51) Int. Cl. E01C 23/16; G06F 8/656; H04W 4/40

(52) U.S. Cl. CPC E01C 23/163; H04W 4/40; G06F 8/656

(57) ABSTRACT

A field programmable controller for controlling the components of roadway marking equipment mounted on a vehicle. The controller includes a general-purpose computer and a microcontroller for controlling and monitoring roadway marking equipment and which further maintains the operational state of the roadway marking equipment during reprogramming of the microcontroller. A wireless transceiver in communication with the internet for receiving software update data is also included. Finally, the controller has a configurable state machine responsive to the microcontroller and configured for: defining the start-up operational state of the components; maintaining a predetermined operational state of the components during the time the computer and microcontroller is being reprogrammed with software update data; and maintaining the operational state of the components for normal operation.

### RELATED APPLICATION

This application claims the benefit of priority to U.S. Patent Application No. 62/562,685 titled “ROADWAY MARKING EQUIPMENT FIELD PROGRAMMABLE CONTROLLER,” filed on Sep. 25, 2017, the contents of which are incorporated in this application by reference.

### TECHNICAL FIELD

This invention relates to controllers for controlling the operation of roadway marking equipment including roadway mark locators, inspection apparatuses, markers and other roadway marking equipment, and more particularly to field programmable controllers whereby the reprogramming of these controllers is via a wireless communication channel.

### BACKGROUND OF THE INVENTION

All references, including publications, patent applications, and patents, cited herein are hereby incorporated by reference to the same extent as if each reference were individually and specifically indicated to be incorporated by reference and were set forth in its entirety herein.

Roadway marks are vitally important to the motoring public for safely maintaining and controlling the flow of traffic, and any degradation in the visibility of the roadway markings presents a hazard to the motoring public especially during the evening or nighttime hours.

To maintain the visibility of the roadway markings for the motoring public, governmental agencies or other responsible parties periodically restripe the pre-existing roadway markings to maintain an acceptable visibility standard. This process is commonly referred to as maintenance striping and is preferably automated using a paint vehicle configured with roadway marking equipment to automatically repaint and thereby refurbish the pre-existing roadway marks.

A paint vehicle configured for maintenance striping is disclosed, for example, in International Publication Number WO 2015/127340 A2 filed on Feb. 23, 2015 entitled ROADWAY MAINTENANCE STRIPING APPARATUS.

Additionally, it may be desirable for governmental agencies or other responsible parties to inspect the roadway lines to ensure that the current markings meet the desired requirements of retroreflectivity, presence, dimensions, distance between skip lines, skip line lengths, etc. and other desired roadway mark characteristics. For example, it may be convenient to inspect a roadway mark for defects including discontinuous breaks, partially worn-away portions of mark segments etc. and to determine the GPS location of the defects. The roadway mark inspection process is preferably automated using a paint vehicle or other vehicle configured with roadway marking equipment to automatically inspect and simultaneously determine the geographical location of the deficient roadway markings, and if desired, selectively rehabilitate the deficient roadway markings during the inspection process. A paint vehicle configured for inspecting roadway marks is disclosed, for example, in U.S. patent application Ser. No. 14/594,726 filed on Jan. 12, 2015 and issued as U.S. Pat. No. 9,230,177 on Jan. 5, 2016 entitled APPARATUS, SYSTEMS AND METHODS FOR DETERMINING THE LOCATION OF A ROADWAY MARK OR PORTION THEREOF NOT MEETING STANDARDS and U.S. patent application Ser. No. 13/741,573 filed on Jan. 15, 2013 and issued as U.S. Pat. No. 8,935,057 on Jan. 13, 2015 entitled ROADWAY MARK DATA ACQUISITION AND ANALYSIS APPARATUS, SYSTEMS AND METHODS.

Also, newly repaved roadways will initially have no roadway marks. In order to open the newly repaved roadway to the motoring public, roadway lane marks must first be established. Roadway lane marks are preferably placed onto the newly repaved surface using a paint vehicle equipped with roadway marking equipment to automatically layout and restripe a new roadway mark. An example of a paint vehicle configured for automatically laying out and/or striping roadway marks onto newly paved roadway surfaces is disclosed, for example, in International Publication Number WO 2016/127174 filed on Feb. 8, 2016 entitled ROADWAY MARKER CONTROL SYSTEM.

Further, it may be desirable to record (survey) the geographical location of the roadway marks for roadway marking and other applications using a paint vehicle equipped with roadway marking equipment to automatically survey the roadway marks. For example, it may be desirable to use the geographical location of the roadway lines to guide a snow plow or create a virtual lane fence (geofence) for autonomous vehicle roadway guidance systems. A paint vehicle configured for automatically determining and recording the geographical location of the roadway marks is disclosed, for example, in International Publication Number WO 2013/109591 A2 published on Jan. 16, 2013 entitled ROADWAY MARK LOCATOR, INSPECTOR, AND ANALYZER.

Other roadway marking equipment and technology for performing roadway marking functions is referenced in the following documentation: U.S. patent application Ser. No. 15/082,365 filed on Mar. 28, 2016 entitled ENHANCED ROADWAY MARK LOCATOR, INSPECTION APPARATUS, AND MARKER; U.S. patent application Ser. No. 13/728,062, filed on Dec. 27, 2012 and issued as U.S. Pat. No. 9,298,991 on Mar. 29, 2016 entitled GPS-BASED MACHINE VISION ROADWAY MARK LOCATOR, INSPECTION APPARATUS, AND MARKER; and

U.S. patent application Ser. No. 13/351,829 filed on Jan. 17, 2012, and issued as U.S. Pat. No. 8,467,968 on Jun. 18, 2013 entitled GLOBAL POSITIONING SYSTEM ROADWAY MARKER.

Roadway marking equipment including roadway mark locators, inspection apparatuses and markers typically incorporate a number of interconnected system components configured to perform a desired roadway marking function (such as maintenance striping or layout and striping, etc.) and includes a main programmable controller configured to perform the desired roadway marking function along with the other interconnected system components. These system components including the main programmable controller are preferably mounted onto the paint vehicle.

Besides the main programmable controller, the other system components may include RTK enabled global positioning systems (GPS) and/or inertial navigation systems (INS) for determining the GPS location of roadway marks, imagers for imaging the roadway surface and marks for determining roadway mark GPS location and the geometric attributes of the roadway mark, electric motors for controlling hydraulically operable paint carriages, electronically controlled proportional hydraulic valves, pressurized air control or other systems for controlling the dispensing of roadway marking material including paint and glass beads, retro-reflectometers for determining the retroreflectivity of the roadway marks, paint carriage position sensors for determining the lateral position of the paint carriages including “smart cylinder” technology, a speed sensor for determining the speed of the vehicle, floodlights for illuminating the roadway surface for imaging the roadway marks, lasers for assisting with the alignment of paint carriages and other tasks, a wireless transceiver for transmitting and receiving data (including software update data) to and from the cloud via the internet, a drive shaft encoder or other means for determining an accurate distance and speed of the vehicle, a synchronization system for synchronizing the images of the roadway mark with a GPS position and/or time stamp, and other system components.

The main programmable controller of the roadway marking equipment usually comprises a computer for controlling and processing of data to and from the system components and a secondary controller for controlling and monitoring the operational states of the roadway marking equipment system components. Additionally, some roadway marking equipment may incorporate multiple computers and/or multiple secondary controllers.

The computer is usually in bi-directional communication with the other above-mentioned system components, and all are configured to perform specific roadway marking functions. For example, the computer, the secondary controller, the synchronization system, the GPS and INS systems, an imager and other components may be configured to determine the GPS location of an imaged roadway mark. As another example, the computer, the secondary controller, imagers, drive shaft encoder, paint carriage position sensors, and electric motor and other components may be configured to perform maintenance striping of a pre-existing roadway marking. Further, the computer, the secondary controller and the wireless transceiver may be configured to remotely receive software update data for the roadway marking equipment. The computer may also be in bi-directional communication with a multitude of computer peripherals including a touch screen enabled liquid crystal display, a conventional keyboard and joystick, and other human interface devices.

For example, the computer may comprise a general purpose industrial computer such as model number DS-1000 manufactured Cincoze Co., Ltd. of New Taipei City, Taiwan. Bi-directional communication may be accomplished between the computer and the above-mentioned system components and other peripherals using one or more standard communication standards such as the controller area network (CAN) vehicle bus standard, ethernet, digital visual interface (DVI), and other conventional serial communication standards such as universal serial bus (USB), RS-232, RS-422 and/or RS-485 standards, or other communication standards. The computer may further have an operating system such as Windows 10 or Linux for example, and one or more application programs for performing the desired roadway marking tasks.

The secondary controller may be programmed to control the operational state of the computer and other roadway marking equipment system components such as those mentioned above. The secondary controller may also be programmed to supervise the computer and system components by controlling their individual operational states in response to an equipment or external generated event. Further, the secondary controller may be programmed to monitor one or more operational states of the computer, peripherals and other system components comprising the roadway marking equipment. The monitored operational states may include voltage, current, power and temperature and other physical parameters. Additionally, the secondary controller may incorporate one or more conventional bidirectional communication ports, such as USB, CAN and/or RS-232, RS-422 and RS-485 ports etc. for communicating with the computer and other peripherals, and may also include software to support these communication ports, and additionally have programmable digital input and output ports for receiving and sending digital signals respectively to the system components. The secondary controller may also provide the imagers triggering signals. The secondary controller may also incorporate one or more analog to digital (A/D) converters having analog inputs for inputting, for example, an analog signal representing the DC current flow to the computer.

The secondary controller may be embodied in a conventional microcontroller such as the megaAVR 2560 microcontroller available from Atmel Corporation of San Jose, Calif. (Atmel was recently acquired by Microchip Technology Inc. of Chandler, Ariz.). The microcontroller may be programmed with software (commonly referred to as firmware) for controlling, supervising and monitoring the operation of the roadway marking equipment and its system components, communicating with the computer and other system components, and performing other tasks deemed necessary for the desired operation and performance of the roadway marking equipment.

During the lifetime of the roadway marking equipment it may be necessary or desirable to reprogram (update) the computer and/or the secondary controller software to accommodate equipment hardware and software changes. For example, a new algorithm may be available for the computer to increase computational efficiency, or an operating system update may be become available for the computer. An updated program for the secondary controller may also be available, for example, to improve both functionality and/or accommodate new hardware.

The computer and secondary controller may independently receive software update data from the wireless transceiver using a conventional Wi-Fi or cellular internet connection.

The software update data for both the computer and secondary controller may also be received and hosted either by just the computer or by just the secondary controller. For example, the computer may receive both its own and the secondary controller software update data (the computer then hosts the software update data for the secondary controller) and then reprograms the secondary controller with its respective software upgrades (the secondary controller is then dependent upon the computer for providing the software update data) via a communication channel.

In a similar fashion, the secondary controller may receive both its own and the computer software update data (in this case the secondary controller hosts the software update data for the computer) and then reprograms the computer with its respective software update data (the computer is then dependent upon the secondary controller for providing the software update data) via a communication channel.

However, software update data may only be successfully transferred from the host to the respective dependent computer or dependent microcontroller if both the host and dependent are functioning properly and are configured to receive their respective software update data and are in communication with each other.

When updating the computer, it may be preferable to place the roadway marking equipment system components into a known operational state. For example, computer software updates are usually enabled upon a computer reset. If the computer is processing data and communicating with a motor, the communication between the computer and motor will be lost and the motor will not be controlled until the new software is executed. It would be preferable therefore to power-off the motor before the computer is reprogrammed. Once the software for the computer is updated and the computer is again functioning properly, normal operation can be reestablished.

When updating the secondary controller embodied as a microcontroller, a first software upgrading process may involve specialized hardware which is externally connected to the microcontroller. For example, software updates for the aforementioned megaAVR 2560 microcontroller may be installed with an externally connected programmer such as the ATMEL-ICE, connected to the in-circuit-serial-programmer (ICSP) or other configured ports of the microcontroller. However, this first upgrading process requires the operator of the roadway marking equipment to be familiar with the programmer and microcontroller programming techniques and operation, and further requires the operator to physically connect the programmer to the microcontroller and physically connect the programmer to a separate host computer.

A second software upgrading process for the microcontroller that may be used is to download the new software update data from the host computer to the microcontroller via a serial communication channel without the need for physically connecting an external programmer. Usually this process still requires an operator or other person familiar with programming microcontrollers to physically establish the communication channel by manually connecting a communication cable between the host computer and microcontroller. However, for roadway marking equipment having a programmable controller comprising a computer in communication with the secondary controller (microcontroller), the serial communication channel is already established eliminating the need for an operator to physically connect the computer to the microcontroller.

To implement the second software upgrading process requires a special program, commonly referred to as a (first) bootloader program, be first installed onto the microcontroller. The first bootloader program for this upgrading process is executed upon a microcontroller reset and allows new software update data to over-write and replace the previous software stored in the microcontroller's flash memory (the microcontroller is reprogrammed). The first bootloader program then directs the microcontroller to begin executing the new software.

The software upgrade may be received from a host computer and transmitted to the microcontroller over a serial communication channel. Additionally, this process may be further improved so that it is completely automatic having the host computer automatically initiate the microcontroller software upgrade process. Alternately the software upgrade process may be downloaded from the computer to an intermediary controller (which may be embodied as a second microcontroller), the intermediary controller configured for transmitting the software update data to the microcontroller. The second microcontroller may also be configured to facilitate the serial communication channel implementation between the computer and microcontroller.

A third software upgrading technique that may be used is to use a second bootloader program (different from the first bootloader program) in addition to an uploader program. The uploader program receives the new software from the host computer during normal communication between the computer and the microcontroller and stores the new software in additional microcontroller memory separate from the currently stored software but does not replace the currently stored software at the time of the upload. The integrity of the new software stored in memory can be verified using, for example, checksums, or other data integrity techniques.

Upon a subsequent microcontroller reset, the second bootloader program is executed. If the new software is available and its integrity verified, the second bootloader then replaces the current software data with the new software update data and then directs the microcontroller to begin executing the new software. For the third software upgrading process, the second bootloader does not receive the new software via serial communication with the host computer as was the case for the second software upgrading process because the new software has already been previously stored in memory by the uploader. However, additional microcontroller memory (internal or external memory) is required with this process to store the additional new software in addition to the current software.

The first and second bootloader functions may also be combined. Other software upgrading processes exist and may include, for example, upgrading the software over a conventional ethernet connection.

For roadway marking equipment it is therefore desirable that upgrading software in the field should be seamlessly implemented without the need for any operator intervention and, therefore, having the computer already in communication with the microcontroller and automatically downloading the software without any operator intervention is the preferred software update process. Both the second and third software upgrade processes achieve this goal and are the preferred methods to upgrade the microcontroller software.

Replacing the current software with new software for the microcontroller usually begins by resetting the microcontroller which then forces the microcontroller to first execute the respective bootloader program (the first bootloader program for the second software upgrade process and the second bootloader program for the third software upgrade process) before executing the main program.

Upon reset and for the second software upgrading process, the first bootloader program first determines if new software is available from the computer or other external source via the serial communication channel. If new software is available, the first bootloader receives the software upgrade from the computer host (or intermediary second microcontroller) and installs the software upgrade replacing the current software with the new software and then directs the microcontroller to begin executing the newly installed software. If new software is not available, the bootloader upon a reset then directs the microcontroller to begin executing the currently installed software.

Upon reset and for the third software upgrading process, the second bootloader program first determines if new software has been previously stored in memory by the uploader, verifies the integrity of the new software, and then installs the software upgrade replacing the current software with the new software. The second bootloader program then directs the microcontroller to begin executing the newly installed software.

Both of the above-mentioned software upgrade processes require the resetting the microcontroller to begin execution of the bootloader program. Resetting of the microcontroller may be accomplished by depressing a reset switch connected to the reset pin of the microcontroller, an external integrated circuit connected to the reset pin of the microcontroller for generating a reset signal such as Texas Instruments Inc. (Dallas, Tex.) integrated circuit TPS3852, an intermediary second microcontroller connected to the microcontroller reset pin, a microcontroller internally software generated hard reset, an internal watch dog generated time-out reset signal, a host computer generated signal, or other means to force the microcontroller into a reset condition.

For the second and third preferred software upgrade processes, generating a reset will initiate the software upgrade process, and if software update data is available, reprograms the microcontroller with the new software. However, during the reset and reprogramming periods the input and output pins of the microcontroller are placed into a high impedance state effectively making the microcontroller inoperable. If the microcontroller controls the on-off operational state of the computer for example, the inoperable state of the microcontroller may cause the host computer to completely power down rendering the roadway marking equipment non-functional.

Additionally, other microcontroller-controlled system components may also be forced to completely power down or reset as the result of the I/O pins of the microcontroller being placed into high impedance state thereby rendering the roadway marking equipment inoperable. Also, the microcontroller cannot monitor the operational state of the system components during the reset or the reprogramming times. It is therefore preferable that the operational state of the roadway marking equipment be maintained throughout the reset and software reprogramming times.

Thus, there is a need in the roadway marking industry for a programmable controller and method that maintains the desired operational state of roadway marking equipment system components during the defined normal operational state, during the initial power-on period of the system and during the reprogramming periods of the computer and/or secondary controller. Further there is a need in the roadway marking industry for a programmable controller that is wirelessly programmable from a remote location without requiring operator intervention.

### BRIEF SUMMARY OF THE INVENTION

To meet the needs identified above and others which will be apparent from a review of the current roadway marking technology and in view of its purposes, the present invention provides a new and improved programmable controller and method for accurately maintaining the operational state of roadway marking equipment during the software upgrading process.

To overcome the shortcomings of current roadway marking equipment, a new apparatus and method for upgrading software (reprogramming) of roadway marking equipment controllers are provided. A basic object of the invention is to provide a field programmable controller for controlling, supervising and monitoring roadway marking equipment.

Another object of the invention is to provide a programmable controller for controlling, supervising and monitoring roadway marking equipment.

Another object of the invention is to provide a programmable controller for controlling, supervising and monitoring roadway marking equipment and which further defines the operational state of the roadway marking equipment during the initial powering-on period.

Another object of the invention is to provide a programmable controller for controlling, supervising and monitoring roadway marking equipment and which further maintains the operational state of the roadway marking equipment during reprogramming of the controller.

Another object of the invention is to provide a programmable controller which can be remotely programmed for controlling, supervising and monitoring roadway marking equipment and which further maintains the operational state of the roadway marking equipment during reprogramming of the controller.

Another object of the invention is to provide a programmable controller which can be wirelessly programmed for controlling, supervising and monitoring roadway marking equipment and which further maintains the operational state of the roadway marking equipment during reprogramming of the controller.

Another object of the invention is to provide a programmable controller comprising a computer and a secondary controller for controlling, supervising and monitoring roadway marking equipment.

Another object of the invention is to provide a programmable controller comprising a general-purpose computer and a secondary controller for controlling, supervising and monitoring roadway marking equipment.

Another object of the invention is to provide a programmable controller comprising a general-purpose computer and a programmable secondary controller for controlling, supervising and monitoring roadway marking equipment.

Another object of the invention is to provide a programmable controller comprising a general-purpose computer and a programmable secondary controller for controlling and monitoring roadway marking equipment and which further maintains the operational state of the roadway marking equipment during reprogramming of the controller.

Another object of the invention is to provide a programmable controller comprising a general-purpose computer and a programmable secondary controller for controlling and monitoring roadway marking equipment and which further maintains the operational state of the roadway marking equipment during reprogramming of the secondary controller.

Still another object of the invention is to provide a programmable controller comprising a general-purpose computer and a microcontroller for controlling and monitoring roadway marking equipment and which further defines the operational state of the roadway marking equipment during the initial powering-on period of the microcontroller.

Yet still another object of the invention is to provide a programmable controller comprising a general-purpose computer and a microcontroller for controlling and monitoring roadway marking equipment and which further maintains the operational state of the roadway marking equipment during reprogramming of the microcontroller.

Yet still another object of the invention is to provide a programmable controller comprising a general-purpose computer and a microcontroller for controlling and monitoring roadway marking equipment and which further maintains the operational state of the roadway marking equipment after the reprogramming of the microcontroller.

Another object of the invention is to provide a programmable controller which maintains an operational state of the roadway marking equipment system components during the reprogramming of the computer.

Another object of the invention is to provide a programmable controller which maintains a defined operational state of the roadway marking equipment system components during the reprogramming of the computer.

Yet another object of the invention is to provide a programmable controller in which the start-up operational state of the controller is programmable.

In one embodiment, the invention comprises a field programmable controller for controlling components of roadway marking equipment mounted on a vehicle. The field programmable controller may include: (1) a wireless transceiver configured to communicate with a network and request and receive software update data; (2) a computer, having computer memory, in wired or wireless communication with the wireless transceiver and the components of the roadway marking equipment; (3) a microcontroller, having program memory, in wired or wireless communication with the computer; and (4) a state machine, in wired or wireless communication with the microcontroller. The computer may be configured to: (a) receive the software update data from the wireless transceiver and store the software update data, (b) communicate the software update data, and (c) receive component data from the components of the roadway marking equipment and based on the component data received, communicate instructions for performing roadway marking tasks, stored in the computer memory, to the components of the roadway marking equipment. The microcontroller may be configured to: (a) control the operational state of the components of the roadway marking equipment during performance of roadway marking tasks, (b) receive and store software update data from the computer, and (c) update the computer memory or program memory with the software update data. The state machine may be configured to: (a) define and control the start-up operational state of the components of the roadway marking equipment, (b) maintain a operational state of the components of the roadway marking equipment during the times the computer memory or program memory are being updated with software update data, and (c) maintain the operational state of the components of the roadway marking equipment during normal operation.

In one embodiment upon the startup of the vehicle, the computer may automatically compare the software update data available on the network with the software update data stored in the computer memory and program memory and determines if there is a difference. In a further embodiment, when the software update data available on the network is different from the software update data stored in the computer memory or program memory, the computer may transmit the software update data available on the network to the microcontroller. In another embodiment, the microcontroller may update the computer memory or program memory with the software update data available on the network.

In another embodiment the computer is configured to compare at the direction of an operator (e.g., via the use of a keyboard), the software update data available on the network with the software update data stored in the computer memory and program memory and determine if there is a difference.

In a further embodiment, at a specified interval the computer may automatically compare the software update data available on the network with the software update data stored in the computer memory and program memory and determine if there is a difference. In one embodiment, such an interval may be continuous.

In one embodiment, the computer does not power down when the computer memory or program memory is updated.

In another embodiment, an update to the computer memory may change the instructions for performing roadway marking tasks in relation to the component data received.

In a further embodiment, the state machine may further comprise pull-down resistors or pull-up resistors, OR gates, AND gates, a Q-bar output, and a flip-flop. In one embodiment, the combined number of pull-down resistors and pull-up resistors in the state machine is at least four. Furthermore, the state machine may include a field programmable gate array or a complex programmable logic device.

In one embodiment, the field programmable controller may include an input to a voltage translation circuit connected to an output of the state machine.

In another embodiment a system for updating software for controlling components of roadway marking equipment mounted on a vehicle in the field is disclosed. The system includes a wireless transceiver in communication with: a network and a computer having computer memory on which a stored version of software for controlling components of the roadway marking equipment resides, the computer being in communication with a microcontroller having program memory on which the stored version of the software for controlling components of the roadway marking equipment resides, the microcontroller being in communication with a state machine. The computer, through the wireless transceiver, requests and receives an online version of software for controlling components of the roadway, from the network. The computer then compares the stored version of the software to the online version of the software and upon the determination of a difference between the online version and the stored version the computer updates the program memory with the online version of the software and then the microcontroller updates the computer memory with the online version of the software. Furthermore, during the update the state machine maintains an operational state of the components of the roadway marking equipment and the components of the roadway marking equipment.

Other objects will become apparent in view of the present invention.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a diagrammatic side view of a vehicle fitted with the apparatus according to the present invention, illustrating system components of the apparatus;

FIGS. 2A, 2B and 2C in combination illustrate a schematic block diagram of a system of the preferred embodiment of the invention for replicating roadway marks (maintenance striping), placing guide indicia and roadway marks onto a newly paved roadway surface (layout and striping), determining the geographical location of roadway marks (surveying roadway marks), inspecting roadway marks and performing other roadway marking tasks;

FIGS. 3A and 3B in combination illustrate a schematic block diagram of a first state machine of the preferred embodiment specifically showing the control logic circuit for defining the programmed start-up, normal and reprogramming operational states of the first state machine output lines;

FIG. 4 is a schematic block diagram of a second state machine of the preferred embodiment specifically showing the control logic circuit for defining the programmed start-up, normal and reprogramming operational states of the second state machine output lines;

FIG. 5 is a schematic block diagram of an example of a power control and monitoring circuit for maintaining the operational power state of the computer and other system components of the preferred embodiment during the programmed start-up, normal operation and reprogramming times;

FIG. 6 is a timing diagram of the state machine output digital signals for controlling the power control and monitoring circuit during the programmed start-up, normal operation and computer and microcontroller reprogramming times; and

FIGS. 7A, 7B, 7C, 7D, 7E, 7F and 7G in combination illustrate an operational flow chart for the schematic block diagram of FIG. 5 for maintaining the operational power state of the system components of the preferred embodiment during the programmed start-up, normal operation and computer and microcontroller reprogramming times.

### DETAILED DESCRIPTION OF THE INVENTION

A brief summary of the systems and apparatuses which may be deployed on a paint vehicle to accomplish one or more of the above roadway marking tasks is now disclosed. It is understood that the disclosed systems and apparatuses are not intended to be exhaustive, but rather are included for the reader's benefit to more fully appreciate the implications and ramifications of the invention to roadway marking equipment and to the roadway marking industry in general.

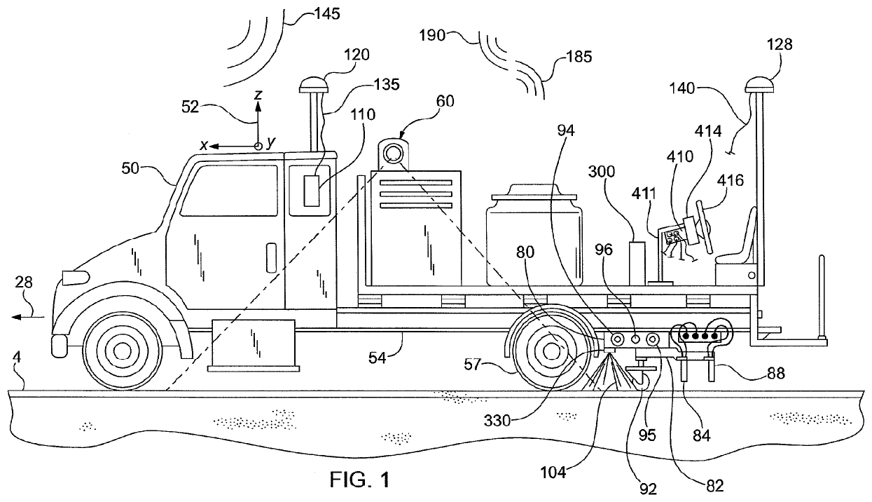

Referring now to the drawing, in which like reference numbers refer to like elements throughout the various figures that comprise the drawing, FIG. 1 shows a paint vehicle 50 travelling in a longitudinal forward direction 28 on top of a roadway surface 4. Vehicle 50 further has a defined Cartesian coordinate system 52 with X, Y and Z axis centered over the cab and is equipped with roadway marking equipment for performing the roadway marking tasks such as maintenance striping of pre-existing marks, layout and striping of newly paved roadway surfaces, inspection of pre-existing roadway marks such as center and edge lines, and surveying of pre-existing roadway marks. Vehicle 50 is equipped with the system components required for performing one or more of the above-mentioned tasks.

It is understood that the term “vehicle” is given its broadest meaning, including any conveyance, motorized device, or moving piece of mechanical equipment for transporting passengers or apparatuses. More specific and preferred examples of vehicles are trucks and road marking machines.

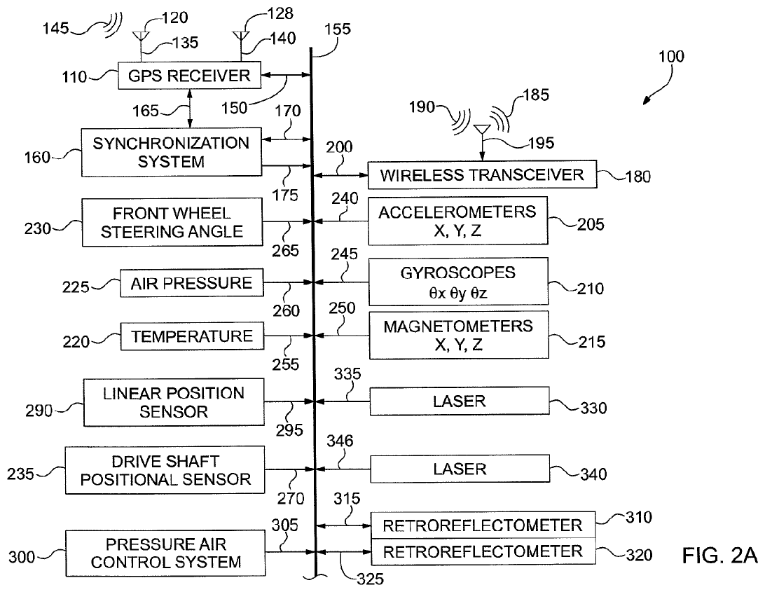

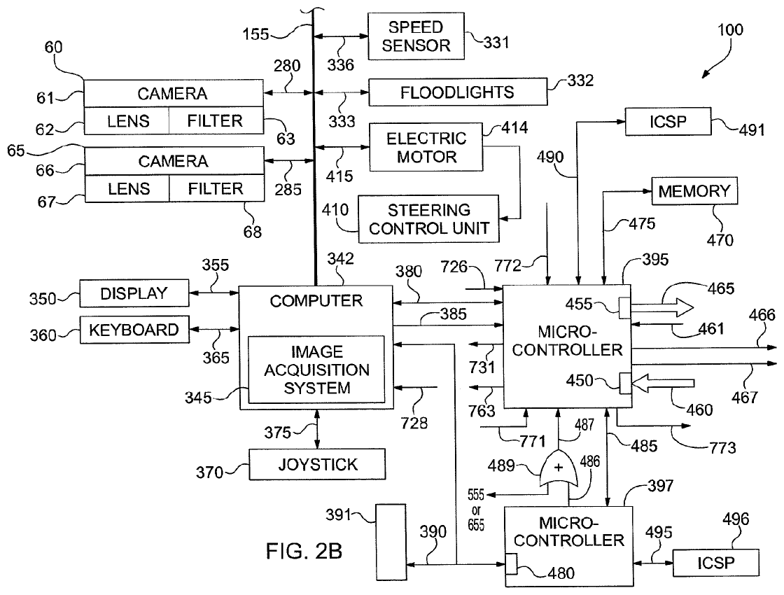

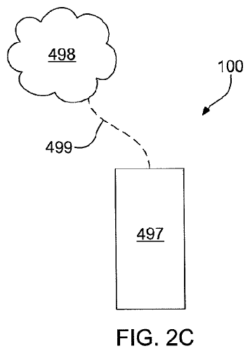

Referring now additionally to FIGS. 2A, 2B and 2C paint vehicle 50 includes a roadway marking system 100 comprising a dual antenna RTK enabled GPS receiver 110 physically located in the rear of the cab of vehicle 50. GPS receiver 110 is connected to GPS antennas 120 and 128 via electrical lines 135 and 140 respectively, and are positioned on vehicle 50 to receive GPS signals 145. Antenna 120 is mounted on the forward driver's side of vehicle 50 and antenna 128 is longitudinally (X axis direction) aligned with antenna 120 and is mounted on the rearward driver's side of vehicle 50.

The RTK enabled GPS receiver 110 is also electrically connected via local bi-directional communication bus 150 to main bi-directional communication bus 155. GPS receiver 110 is also in bi-directional communication with synchronization system 160 via bus 165. Synchronization system 160 is also electrically connected via local bi-directional communication bus 170 and line 175 to main communication bus 155.

Vehicle 50 is further equipped with a wireless transceiver 180. Wireless transceiver 180 is configured to transmit and receive multiband signals 185 and 190 respectively via multiple antennas 195 (shown as a single antenna symbol). For example, transceiver 180 may be configured to receive and transmit data signals over a conventional cellular communication network. The cellular communication network may also communicate software update data and other data, for example roadway mark path data and RTK correctional data, wirelessly to vehicle 50. Transceiver 180 may also be configured to receive and transmit data signals over a Wi-Fi communication network for wirelessly communicating software update data and other data to vehicle 50. For example, transceiver 180 communicates with the cloud 498 and is in communication with a remote server 497 having software update data and other data. Other data may include roadway mark path data, including GPS location data and image data of the roadway marks. Server 497 communicates with the cloud via a communication channel 499.

An example of a wireless transceiver 180 configured for receiving and transmitting both Wi-Fi and cellular signals is model number WR44R (TransPort) manufactured by Digi International of Eden Prairie, Minn. Wireless transceiver 180 is further connected to bi-directional bus 155 via local bi-directional bus 200.

Vehicle 50 is also be equipped with accelerometers 205 which measure the acceleration of vehicle 50 in the X, Y and Z axis of coordinate system 52, gyroscopes 210 which measure the angular accelerations of rotations around axis X, Y and Z of coordinate system 52, magnetometers 215 which measure the magnetic field intensity in the X, Y and Z axis of coordinate system 52, ambient temperature sensor 220, ambient air pressure sensor 225, front wheel steering angle sensor 230, and drive shaft positional sensor 235, with all of the above being connected to bi-directional bus 155 via their individual local busses 240, 245, 250, 255, 260, 265 and 270 respectively.

The RTK enabled GPS receiver 110 along with accelerometers 205, gyroscopes 210, magnetometers 215, temperature sensor 220 and air pressure sensor 225 may all be incorporated into a single inertial navigation system 275 (INS) (not shown). An example of an inertial navigation system 275 is model number Spatial Dual manufactured by Advanced Navigation of New South Wales, Australia. Another example of an INS 275 is model Apogee D manufactured by SBG Systems headquartered in Carrieres-sur-Seine, France. Positional data is processed by an internal computer incorporated within the INS 275 and may use a Bayesian-based filter to determine the GPS location of coordinate 52 of vehicle 50 (offset corrected), and additionally may use data for example from drive shaft positional sensor 235, front wheel steering angular sensor 230 and other sensor data. The INS 275 would also connect to the bi-directional bus 155 via bus 276 (not shown).

Vehicle 50 is also equipped with GPS calibrated, downwardly focused enclosed imaging systems 60 and 65 mounted on the driver and passenger sides of vehicle 50, respectively. Imaging system 60 is positioned on the driver's side of vehicle 50 to image a rectangular area 70 (not shown) extending longitudinally alongside of, and laterally outward (Y axis direction) from, vehicle 50 to image center line or other roadway marks, and imaging system 65 is positioned on the passenger's side of vehicle 50 to image a similar rectangular area 75 (not shown) on the passenger side of vehicle 50. Imager 65 may also image additional multi-lane roadway marks and/or edge lines.

Imaging systems 60 and 65 are identical and may include CCD or CMOS implemented cameras 61 and 66, lenses 62 and 67, and may include optical filters 63 and 68 (including polarizers), respectively. The imagers are calibrated such that each pixel position in image space has a corresponding GPS position in object space. Imaging systems have further been calibrated for lens and perspective distortions using conventional image calibration techniques. Both imaging systems 60 and 65 connect to bi-directional bus 155 via their respective local busses 280 and 285 respectively.

Imaging systems 60 and 65 may be used in cooperation with the INS 275 or RTK enabled GPS receiver 110 (which may cooperate with a inertial measurement unit) to determine the GPS geographic location of the imaged roadway mark. Synchronization system 160 synchronizes the roadway images obtained by imaging systems 60 and 65 to a GPS geographical location determined by GPS receiver 110 (or the INS 275). The roadway mark images may also be timed stamped using UTC data obtained from the GPS receiver 110 or INS 275, or by other means including conventional network or precision time protocol sources (not shown).

Vehicle 50 is also equipped with a laterally moveable paint carriage 80 which is supported by extendible cylindrical shaped support arms 94 and 95. A paint and bead gun support member 82 is moveably affixed to carriage 80 and supports outward positioned paint gun 84 and inward positioned paint gun 86 (not shown) and their respective outward and inward positioned reflective bead guns 88 and 90 (not shown). A vertical load bearing rotatable wheel 92 is attached to gun support member 82 and is in contact with roadway surface 4. Wheel 92 vertically supports gun support member 82 when carriage 80 is in an extended position away from vehicle 50. Vehicle 50 may also be equipped with an identical carriage 130 (not shown) on the passenger side.

A hydraulic cylinder 412 (not shown) having piston 440 (not shown) connected to piston rod 447 (not shown) is attached to frame 54 of vehicle 50 and is positioned between support arms 94 and 95. The distal end of piston rod 447 is attached to the extendible end of carriage 80 at attachment point 96. Hydraulically powering piston 440 provides the necessary force to laterally extend or retract carriage piston rod 447 (and therefore paint carriage 80) from paint vehicle 50, thereby controlling the lateral positioning of paint guns 84 and 86 and respective bead guns 88 and 90 over a desired roadway mark position.

The lateral position of carriage 80 is controlled by a conventional hydraulically powered steering control unit 410, which may be manually controlled via steering wheel 416 or electrically controlled via electric motor 414. A manufacturer of steering control units is the Eaton Corporation of Beachwood, Ohio. The lateral position of carriage 80 may also be hydraulically controlled using a proportional valve communicating with computer 342 via a standard serial or other communication channel such as CAN or RS-232 interfaces.

Motor 414 may be a conventional direct drive permanent magnet synchronous motor (PMSM), having high torque and low operational rotational velocity. Motor 414 is further adapted to be easily installed and retrofitted onto the steering control unit 410 without requiring special modifications to either steering wheel 416, steering control unit 410 or support stand 411. Motor 414 connects to the main bus 155 via local bus 415.

To determine the lateral position of the carriage a linear position sensor 290 (for example, a conventional draw wire sensor) is mounted having one end connected to the frame 54 and the other end at the distal end of carriage 80. Other linear positioning sensors may be used, such as sensors integrated into the hydraulic cylinder. Using the linear position sensor data, the GPS location of the paint nozzles 84 and 86 and bead nozzles 88 and 90 can be determined (offset adjusted), or the location of the paint nozzles 84 and 86 and bead nozzles 88 and 90 with respect to any point on vehicle 50 (offset adjusted) can also be determined. Local bus 295 connects the linear position sensor 290 to the main bus 155.

Thus, it is understood that the relative lateral positional movement of carriage 80 with respect to frame 54 is determined by sensor 290, and relative distances moved by carriage 80 can be calculated from differences in position locations. Additionally, the GPS position of carriage 80 relative to a chosen vehicle coordinate system is conventionally determined considering positional offsets, and therefore the GPS positions of each paint and bead guns as well as their respective projections onto roadway surface 4 is determined relative to a chosen vehicle coordinate system, again considering their respective positional offsets. It is also understood that the absolute GPS position of carriage 80 and each paint and bead guns as well as their respective projections onto roadway surface 4 is known, again considering their respective positional offsets which have been conventionally determined.

Vehicle 50 is further equipped with laser line generator 330 mounted underneath the frame of carriage 80 (on driver's side carriage) having a fanned pattern of laser light 104 downwardly focused onto and longitudinally aligned with vehicle 50 and intersecting with, roadway surface 4 thereby producing line pattern 106 (not shown). Pattern 106 may be aligned with or offset from the paint and bead guns. A similar laser line generator 340 is mounted on carriage 130. Lasers 330 and 340 may also produce a dot or other patterns (such as a cross pattern). Line generators 330 and 340 are connected to main bus 155 via local busses 335 and 346 respectively.

Lasers 330 and 340 may also be configured to produce a cross-hair pattern intersecting the roadway surface 4 for manually recording the position of the roadway mark path using the linear position sensor 290 in combination with the RTK enabled GPS receiver 110 or INS 275 as further described in US Patent Application Publication US2016/0209511.

As carriage 80 moves in a lateral direction inward and outward from vehicle 50, line 106 also moves giving a visual indication (for a visible laser line generator) of the lateral position on carriage 80. The lateral positions of the paint guns 84 and 86, and bead guns 88 and 90 (and their respective projections onto roadway surface 4) are therefore also visually indicated by line 106 taking into consideration any fixed offsets between the paint and bead guns and laser line 106. The laser line 106 can be imaged with imager 60 and, accounting for offsets, the GPS positions (and the positions with respect to coordinate system 52) of the paint guns 84 and 86, and bead guns 88 and 90 (and their respective projections onto roadway surface 4) can be determined.

For example, a GPS calibrated imager 60 is able to determine the GPS position in object space of each pixel, and hence can determine the GPS position in object space of the imaged laser line (or dot) 106. Imager 60 can also image both the roadway mark and laser line 106 and determine the relative lateral distance difference between the roadway mark and the paint guns 84 and 86 and bead guns 88 and 90 (offset corrected). A control system may then use this lateral distance difference (in image space, object space or combination) to control the lateral position of carriage 80 to position the paint guns 84 and 86 and bead guns 88 and 90 paint over the desired roadway mark. Imager 60 may also be mounted on the carriage 80, in which case an image representation of the locations of the paint and bead guns are known (the lateral distances between the imager 60 and paint and bead guns are fixed and known). In this case the image of laser line 106 is not required. In a similar fashion, imager 65 may be mounted on carriage 130.

Vehicle 50 is further equipped with a conventional pressurized air control system 300 which is affixed to frame 54. Air control system 300 controls the pressurized air to the paint and bead paint guns 84 and 86 and bead guns 88 and 90 in response to an electrical signal which turns the guns on and off thereby controlling the dispensing of paint and bead onto the roadway surface 4. Air flow is distributed to the guns via flexible hoses (shown in FIG. 1 but not labelled). Bus 305 connects air control system 300 to bus 155. Other systems may be available to actuate the paint and bead guns.

Vehicle 50 is further equipped with driver side mounted conventional mobile retroreflectometer 310 and passenger side conventional retro-reflectometer 320 (both not shown). Retroreflectometers 310 and 320 are individually connected to main bus 155 via local busses 315 and 325 respectively. An example of a mobile retroreflectometer is model LTL-M mobile by Delta Light & Optics, Denmark.

Vehicle 50 is also equipped with one or more floodlights 332 which are connected to main bus 155 via local bus 333. Floodlights 332 are used to illuminate the roadway surface 4 for imaging roadway marks (using imagers 60 and 65) in low or non-existent ambient light conditions such as in the evening or nighttime hours.

Vehicle 50 is also equipped with a speed sensor 331 which determines the speed of vehicle 50. Speed sensor 331 is connected to main bus 155 via local bus 336. Speed sensor 331 for example can be used to control the dispensing of roadway mark paint and bead material, adjusting the amount of dispensed material according to the speed of vehicle 50 (more material is dispensed at faster vehicle speeds to maintain consistent paint thickness and bead distribution, and vice versa). Speed sensor 331 in combination with computer 342 can also be used to calculate distance travelled by vehicle 50.

Vehicle 50 is also equipped with conventional computer 342 having communication ports such as universal serial buses (USB) for communicating with external peripherals such as external memory, memory sticks and other USB compatible peripherals. Additional communication ports are provided which may include wired or wireless ports, such as Ethernet, EIA-232, EIA-422, EIA-485, Bluetooth, etc. Bus 155 may contain a number of different communication protocols such as CANOpen, RS-232, RS-485, camera link, ethernet etc. Bus 155 connects to computer 342.

Computer 342 is in bi-directional communication with all other system components connected to bus 155. Additionally, each component is in communication with every other component. The component data is placed onto bus 155 and may be subsequently processed by computer 342. Processed output data is then placed onto bus 155 by computer 342 and received as processed output data by the respective components to perform the desired tasks for replicating roadway marks (maintenance striping), placing guide indicia and roadway marks onto a newly paved roadway surface (layout and striping), determining the geographical location of roadway marks (surveying roadway marks) and inspecting the roadway marks.

This data (data originating from the system components to computer 342 or data originating from computer 342 to the system components, or data flowing between the system components) is collectively referred to as roadway mark data and includes for example, the INS 275 derived location data, linear position sensor 290 data, image data from imagers 60 and 65 of the roadway marks visible on the roadway surface 4, electric motor data 414 such as motor command and diagnostic data, proportional hydraulic valve data, retroreflectometers 310 and 320 retroreflectivity data, synchronization system 160 data, wireless transceiver 180 data, lasers 330 and 340 data, microcontrollers 395 and 397 data, drive shaft encoder positional sensor 235 data and other data to and from other connected system components connected to bus 155. Roadway mark data also includes data to control and monitor the operational states of the components, such as the image trigger signals for imagers 60 and 65, motor 414 positional command data, state machine signals etc.

Computer 342 additionally has internally available peripheral component interconnect (PCI) expansion slots and/or peripheral component interconnect express (PCIe) expansion slots. For example, computer 342 may be provided with a conventional PCIe input-output board inserted into a PCIe compatible expansion slot for sending digital control signals from computer 342 to other system components, such as conventional roadway mark material pressurized air control system 300, and for receiving digital signals from external peripherals to computer 342. Computer 342 may also, for example, have additional input and output signal ports, such as the digital input/output connector available on the Cincoze Co. model DS-1000 computer mentioned above.

Computer 342 further includes image acquisition system 345 for interfacing imagers 60 and 65 with computer 342. Acquisition system 345 may include conventional frame grabber PCIe expansion slot compatible image frame grabber card such as model number NI PCIe-1433, a high-performance camera link frame grabber card manufactured by National Instruments Corporation of Austin, Tex. System 345 also includes a random-access memory (RAM) buffer for storing acquired images from imagers 60 and 65, and handles all of the software overhead (control, image data transfers, etc.) for interfacing imagers 60 and 65 to computer 342.

Cameras 61 and 66 may also be ethernet enabled in which case image data is transferred via a standard ethernet connection directly to the computer 342 via a high speed ethernet interface card or other means.

Acquisition system 345 further has an external image trigger input 728 for receiving an external trigger signal. Acquisition system 345 in response to an external trigger signal placed onto input 728, sends a control signal to imager 60 (and/or imager 65) via busses 155 and 280 (busses 115 and 285) to acquire or otherwise “snap” an image. Image data (pixel grayscale or color data and pixel location values) are then transferred from imagers 60 and/or 65 to the on-board buffer memory of acquisition system 345 via the respective busses and then subsequently transferred to data memory of computer 342. If the cameras are ethernet enabled, image data is transferred directly into the memory of computer 342. Acquisition system 345 may also respond to software instructions from computer 342 to acquire image data from imagers 60 and 65.

An external trigger source (not shown) generates and accurately controls the timing of the external trigger signal and may be programmed by computer 342 to produce various trigger signals. For example, the trigger source may be programmed to generate a periodic or an asynchronous trigger signal. In response to the trigger signal, imager 60 (and/or imager 65) acquires a sequence of images having accurate and known time intervals between each acquired image. Also, cameras 61 and 66 may be directly triggered bypassing image acquisition system 345. Images may also be timed stamped.

A sequence of images may then be acquired in response to an external trigger signal or derived from a free running signal (asynchronously triggered). The trigger signal source may be a conventional programmable signal generator, or may be derived from the computer 342 internal timer, a timing module 749 (not shown), an external microcontroller based system or any GPS receiver 110, or from acquisition system 345 or synchronization system 160, or originate from microcontroller 395, or from other sources including imagers 60 and 65.

It is therefore understood that images may be acquired by imager 60 (and/or imager 65) and placed into data memory of computer 342 in response to the occurrence of an external or internally generated (i.e. by software) trigger signal, the timing of which may be accurately maintained and controlled by the trigger signal source or computer 342 respectively or an asynchronously derived source. The acquired image is stored in the memory of computer 342 as an array of grayscale (or color) values having a one to one correspondence to the pixel array. For example, a CCD sensor having a 640×480 pixel array will output a 640×480 array of grayscale values (which matches the pixel array). Time stamped data of when the image was obtained could also be stored with the respective image as metadata.

Imagers 60 and or 65 may additionally incorporate color, ethernet enabled cameras such as model number UI-5240RE-C-HQ manufactured by IDS Imaging Development Systems GmbH of Obersulm, Germany. This camera may be directly triggered from the synchronization system 160, or asynchronously triggered (free run mode). Other camera manufactures provide a wide choice of ethernet enabled black and white and color imagers.

The images can be synchronized to a GPS position and/or a UTC time tag via the synchronization system 160.

Computer 342 is further connected to human interface devices including (a) a convention LCD display 350 via bus 355 for displaying information to the operator, (b) conventional keyboard 360 via bus 365 to allow the operator to input data, and (c) to conventional joystick 370 via bus 375. Computer 342 further has non-volatile memory such as a conventional solid-state disk (SSD, not shown) for storing software update data for either itself or for the microcontroller 395, operating system programs, image data and application programs and other data and programs.

Computer 342 further has a dedicated bi-directional communication busses 380 and 390 and output signal line 385. Bus 380 is an RS-232 communication channel and bus 390 is a USB communication channel, although other types of communication channels/busses may be used. Dedicated busses 380 and output signal line 385 flow to microcontroller 395. Output signal line 385 connects to the reset input of microcontroller 395. With computer 342 powered off the busses 380 and 390 and output pin of computer 342 connected to line 385 are in a high-impedance state. Bus 390 connects to intermediary microcontroller 397. Further connected to bus 390 is USB connector 391. With the USB connection disconnected from computer 342, connector 391 permits direct connection to intermediary microcontroller 397.

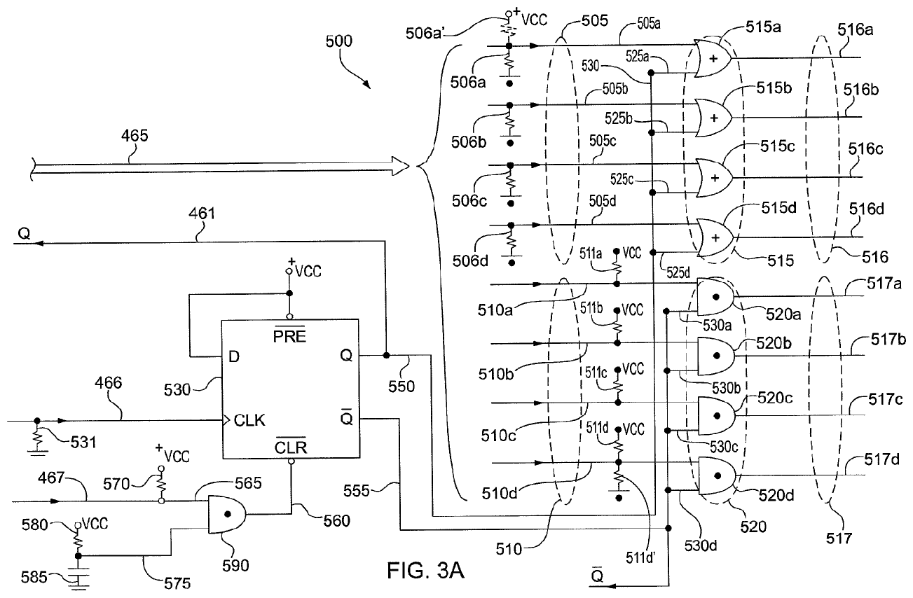

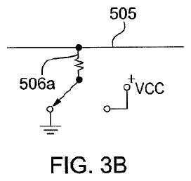

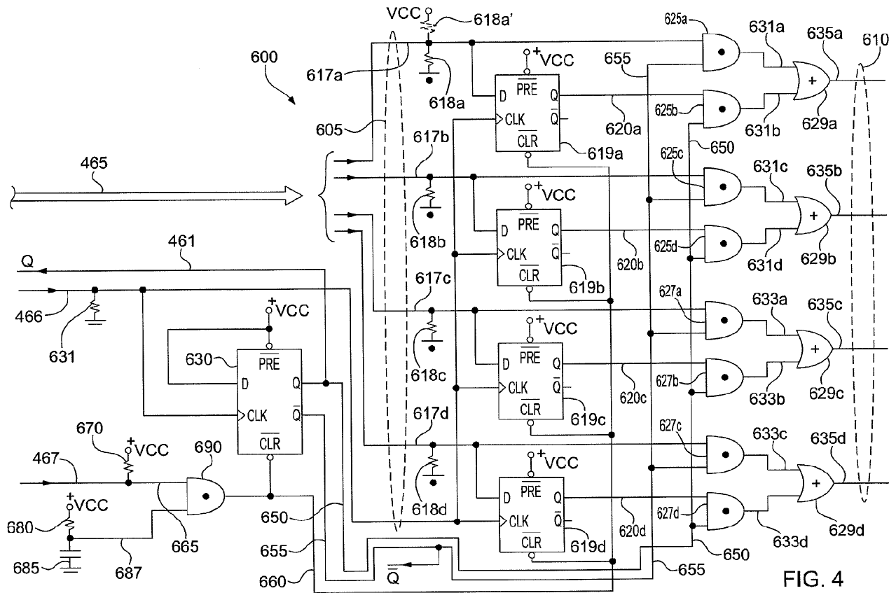

Microcontroller 395 has a number of programmable input and output (I/O) pins 450 programmed as digital inputs, and programmable input and output pins 455 programmed as digital outputs. Configured input pins 450 receive digital signals placed onto bus 460 and configured output pins 455 output digital signals onto bus 465. The individual lines of bus 465 connect to state machines 500 and 600 (discussed later in reference to FIGS. 3 and 4).

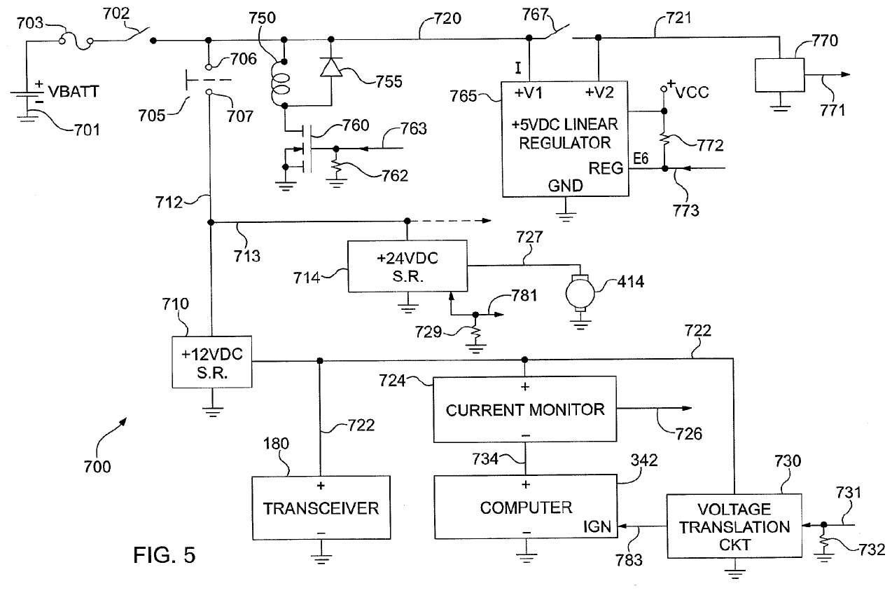

Microcontroller 395 pins further programmed as digital outputs include those pins connected to lines 466, 467, 731, 763, and 773, and pins programmed as digital inputs include those pins connected to lines 385, 461, 487, 771 and 772. The pin connected to line 726 is programmed as an analog input and is used to measure the power current to computer 342 (discussed later with reference to FIG. 5.)

It is noted that upon a microcontroller 395 reset (either by a power-on-reset event, an externally generated reset event via the reset input pin, a watch-dog generated reset event or other types of reset events) all input and output pins are initially placed into a high impedance state. The input reset pin of microcontroller 395 connected to line 385 is pulled high by an external pull-up resistor (not shown).

External non-volatile memory (EEPROM, Flash or combination) 470 is connected to microcontroller 395 via bi-directional bus 475 and may store the new software update data for the third software upgrade process, other data and/or the operational state data of the system 100.

Intermediary microcontroller 397 bi-directionally communicates with computer 342 via bus 390 and communication port 480. Port 480 (configured as an USB communication port) interfaces microcontroller 397 core circuitry with the 390 bus signals. Port 480 but may also be configured as an RS-232 port. Microcontroller 397 is connected to microcontroller 395 via a bi-directional bus 485 which may be configured as a RS-232 bus. The output line 486 of microcontroller 397 connects to one input of OR gate 489 with the output of OR gate 489 connected to line 487. A low logic signal on line 487 causes a reset of microcontroller 395 (as does a low logic signal on line 385). The external conventional logic circuit implementation of combining these two reset signals into one reset signal is not shown for clarity. The other input of OR gate 489 connects to state machine 500 line 555 or state machine 600 line 655. OR gate 489 allows a reset pulse generated by microcontroller 397 to only occur during the reprogramming times for microcontroller 395.

Connected to microcontroller 395 is in-circuit serial programming (ICSP) bi-directional bus 490 which is connected to ICSP connector 491, and also connected to microcontroller 397 is in-circuit serial programming (ICSP) bi-directional bus 495 which is connected to ICSP connector 496. The bootloader programs and other data for both microcontroller 395 and 397 are initially programmed via their respective ICSP buses 490 and 495 through connectors 491 and 496 respectively.

Referring now additionally to FIG. 3, a first state machine 500 is shown. The function of state machine 500 is to maintain the desired operational states of the system 100 components during the start-up period, the reprogramming periods of the microcontroller 395 and/or the computer 342 and during the normal system operation.

State machine 500 connects to microcontroller 395 via bus 465, lines 466, 467 and 461. During operation, microcontroller 395 outputs the desired logic 0 or 1 digital signals onto the individual lines of bus 465 and lines 466 and 467, and inputs the logic 0 or 1 digital signals placed onto line 461.

State machine 500 comprises lines 505a, 505b, 505c, and 505d (collectively referred to as line group 505) and lines 510a, 510b, 510c, and 510d (collectively referred to as line group 510) of bus 465 and which are further connected to the pins of output port 455 of microcontroller 395.

Lines 505a, 505b, 505c, 505d connect individually to pull-down resistors 506a, 506b, 506c, and 506d respectively. Lines 505a, 505b, 505c, 505d further connect individually to one input line of OR gates 515a, 515b, 515c, and 515d respectively. The other lines 525a, 525b, 525c and 525d of OR gates 515a, 515b, 515c, and 515d respectively are all connected together to line 550. Line 550 further connects to the Q output of flip-flop 530 and line 461.

Pull-down resistors 506a, 506b, 506c, and 506d maintain logic 0 signals for input lines 505a, 505b, 505c, and 505d respectively during the software upgrade process (where all input and output lines of the microcontroller 395 are in high impedance, or any other reset condition which forces the input and output pins of microcontroller to a high-impedance state). It is noted that pull-down resistors 506a, 506b, 506c, and 506d may be individually configured as pull-up resistors to power bus +VCC (as shown for line 505a having a dotted pull-up resistor 506a′), in which case the respective pull-up resistor will maintain the logic 1 signal for the respective line for those times that microcontroller 395 respective pin is in a high-impedance state.

The output lines for the OR gates 515a, 515b, 515c, and 515d are 516a, 516b, 516c and 516d respectively (collectively noted as output line group 516). Output lines 516 are used to control the operational state of the system 100 components. OR gates 515a, 515b, 515c, and 515d may be packaged as a conventional quad 2-input OR gate 74HC32 integrated circuit 515 manufactured by Texas Instruments Inc. of Dallas, Tex.

Lines 510a, 510b, 510c, 510d connect individually to pull-up resistors 511a, 511b, 511c, and 511d respectively. Lines 510a, 510b, 510c, 510d further connect individually to one input line of AND gates 520a, 520b, 520c, and 520d respectively. The other input lines 530a, 530b, 530c and 530d of AND gates 520a, 520b, 520c, and 520d respectively are all connected together to line 555. Line 555 further connects to the Q-bar output of flip-flop 530.

Pull-up resistors 511a, 511b, 511c, and 511d maintain the logic 1 signals for input lines 510a, 510b, 510c, and 510d respectively during the microcontroller 395 software upgrade process (where the all input and output lines of the microcontroller 395 are in high impedance or any other reset condition which forces the input and output pins of microcontroller 395 to a high-impedance state). It is noted that pull-up resistors 511a, 511b, 511c, and 511d may be individually configured as pull-down resistors to ground (as shown for line 510d having a dotted pull-down resistor 511d′), in which case the respective pull-down resistor will maintain the logic 0 signals for the respective line during a microcontroller 395 reset condition.

The pull-down or pull-up circuit configuration for the resistors 506a, 506b, 506c, 506d, 511a, 511b, 511c, and 511d and other resistors (618a-618d) can be easily programmed using a SPDT switch as shown in FIG. 3B.

The outputs for the AND gates 520a, 520b, 520c, and 520d are 517a, 517b, 517c and 517d respectively (collectively noted as output line group 517). Output lines 517 are used to control the operational state of the system 100 components. AND gates 515a, 515b, 515c, and 515d may be packaged as a conventional quad 2-input AND gate 74HC08 integrated circuit 520 manufactured by Texas Instruments.

It should be noted that additional AND and OR integrated circuits may be added to increase the number of individual lines of output 516 and 517 line groups as required depending upon the number of system components that require their operational states controlled by microcontroller 395. As an example, the outputs lines 516 and 517 connect to, and are used to define the operational state of an example of a power control circuit 700 shown in FIG. 5. Additionally, the OR and AND gate functionality may be implemented using a conventional field programmable gate array (FPGA).

Flip-flop 530 has the active low preset (PRE-bar) input and the D input connected to +VCC (nominally +5 VDC but is dependent upon the supply voltage specifications for the logic circuits). The active low clear input (CLR-bar) connects to the output line 560 of a single conventional AND gate 74HC08 590. The positive-going edge clock (CLK) connects to line 466. Pull-down resistor 531 is connected to line 466 and maintains line 466 at a logic 0 signal during the microcontroller 395 reset and prevents the CLK input of flip-flop 530 from being logically undefined. Flip-flop 530 is a conventional 74HC74 integrated circuit and is also manufactured by Texas Instruments.

One end of pull-up resistor 570 connects to +VCC and the other end of resistor 570 connects to input line 467, which also connects to input line 565 of AND gate 590. The other input line 575 of AND gate 590 connects to the junction of capacitor 585 and pull-up resistor 580. The other terminal of capacitor 585 connects to ground and the other terminal of resistor 580 connects to +VCC. Thus, resistor 580 in combination with capacitor 585 forms a conventional RC delay circuit which maintains the input line 575 at a logic 0 state during the immediate application of +VCC, thus maintaining line 560 at a logic 0 state for a period of time irrespective of the logic state of line 467. A logic 0 signal on line 560 clears flip-flop 530 and sets line 550 (Q) low.

Referring now additionally to FIG. 4, a second state machine 600 is shown connecting to microcontroller 395 via bus 465 and lines 466, 467 and 461. During operation, microcontroller 395 outputs the desired logic 0 or 1 signals onto the individual lines of bus 465 and lines 466 and 467, and inputs the logic 0 or 1 digital signal placed onto line 461.

State machine 600 comprises lines 617a, 617b, 617c, and 617d (collectively referred to as lines 605) of bus 465 and which are further connected to the pins of output port 455 of microcontroller 395.

Lines 617a, 617b, 617c, and 617d from bus 465 connect individually to pull-down resistors 618a, 618b, 618c, and 618d respectively. Resistors 618a, 618b, 618c and 618d maintain lines 617a, 617b 617c and 617d in a logic 0 state when the respective pins connected to the output lines of microcontroller 395 are in a high-impedance state. Alternatively, any pull-down resistor 618a, 618b, 618c and 618d can be configured as a pull-up resistor maintaining lines 617a, 617b 617c and 617d in a logic 1 state when the respective pins connected to the output lines of microcontroller 395 are in a high-impedance state. For example, resistor 618a′ (shown as a dotted resistor symbol) is configured as a pull-up resistor for line 617a.

Line 617a is further connected to the D input of flip-flop 619a and one of the inputs of AND gate 625a. The other input of AND gate 625a connects to line 655. The output of AND gate 625a connects to line 631a which further connects to one of the inputs of OR gate 629a. The output of OR gate 629a connects to line 635a.

The Q output of flip-flop 619a connects to line 620a which is further connected to one of the inputs of AND gate 625b. The other input of AND gate 625b is connected to line 650. The output of AND gate 625b connects to line 631b which connects to the other input of OR gate 629a.

The PRE-bar input of flip-flop 619a is connected to +VCC. The CLR-bar input of flip-flop 619a is connected to line 660. The clock input of flip-flop 619a is connected to line 466.

Line 617b is further connected to the D input of flip-flop 619b and one of the inputs of AND gate 625c. The other input of AND gate 625c connects to line 655. The output of AND gate 625c connects to line 631c which further connects to one of the inputs of OR gate 629b. The output of OR gate 629b connects to line 635b.

The Q output of flip-flop 619b connects to line 620b which is further connected to one of the inputs of AND gate 625d. The other input of AND gate 625d is connected to line 650. The output of AND gate 625d connects to line 631d which connects to the other input of OR gate 629b.

The PRE-bar input of flip-flop 619b is connected to +VCC. The CLR-bar input of flip-flop 619b is connected to line 660. The clock input of flip-flop 619b is connected to line 466.

Line 617c is further connected to the D input of flip-flop 619c and one of the inputs of AND gate 627a. The other input of AND gate 627a connects to line 655. The output of AND gate 627a connects to line 633a which further connects to one of the inputs of OR gate 629c. The output of OR gate 629c connects to line 635c.

The Q output of flip-flop 619c connects to line 620c which is further connected to one of the inputs of AND gate 627b. The other input of AND gate 627b is connected to line 650.

The PRE-bar input of flip-flop 619c is connected to +VCC. The CLR-bar input of flip-flop 619c is connected to line 660. The clock input of flip-flop 619c is connected to line 466.

Line 617d is further connected to the D input of flip-flop 619d and one of the inputs of AND gate 627c. The other input of AND gate 627c connects to line 655. The output of AND gate 627c connects to line 633c which further connects to one of the inputs of OR gate 629d. The output of OR gate 629d connects to line 635d.

The Q output of flip-flop 619d connects to line 620d which is further connected to one of the inputs of AND gate 627d. The other input of AND gate 627d is connected to line 650.

The PRE-bar input of flip-flop 619d is connected to +VCC. The CLR-bar input of flip-flop 619d is connected to line 660. The clock input of flip-flop 619d is connected to line 466.

The outputs for the OR gates 629a, 629b, 629c, and 629d are noted as line group 610 and signals placed on these lines, for example, control the operational state of the system 100, and more particularly, for example, system 700 referenced in FIG. 5.

OR gates 629a, 629b, 629c, and 629d may be packaged as a conventional quad 2-input OR gate 74HC32 integrated circuit manufactured by Texas Instruments Inc. of Dallas, Tex. Flip-flops 619a and 619b, and flip-flops 619c and 619d, are preferably conventional dual 74HC74 integrated circuit also manufactured by Texas Instruments. AND gates 690, 625a, 625b, 625c, 625d, 627a, 627b, 627c, and 627d are preferably a conventional 74HC08 integrated circuit also manufactured by Texas Instruments.

Line 466 further connects to pull-down resistor 631 and the clock input of flip-flop 630. The Q output of flip-flop 630 connects to line 650 and line 461. The Q-bar output of flip-flop 630 connects to line 655. The CLR-bar input of flip-flop connects to line 660. The D and PRE-bar inputs of flip-flop 630 connect to +VCC.

One end of pull-up resistor 670 connects to +VCC and the other end of resistor 670 connects to input line 467, which also connects to input line 665 of AND gate 690. The other input line 687 of AND gate 690 connects to the junction of capacitor 685 and pull-up resistor 680. The other terminal of capacitor 685 connects to ground and the other terminal of resistor 680 connects to +VCC. Thus, resistor 680 in combination with capacitor 685 forms a conventional RC delay circuit which maintains the input line 687 at a logic state 0 during the immediate application of +VCC, thus maintaining line 660 at a logic state 0 for a period of time irrespective of the logic state of line 467. A logic 0 signal on line 660 clears flip-flops 630 and 619a though 619d. This circuit is similar to that discussed with respect to state machine 500.

It is understood that state machines 500 and 600 may also be implemented using a field programmable gate array (FPGA) or a complex programmable logic device (CPLD), and the invention is not restricted to a particular logic implementation. For setting the pull-up or pull-down states of the input resistors 506a through 506d, 511a through 511d and 618a through 618d, a conventional SPDT switch can be used to program the pull-up or pull-down state for the resistors as previously mentioned.

Referring additionally to FIG. 5, an example of a power controller 700 is shown for controlling the operational power state power of the computer 342, the wireless transceiver 180, the +VCC (+5 VDC) regulator, and the microcontroller 395. Other components may be added. Although the operational power state of the stated components in this example is being controlled, the invention is not limited in any way by this example and other component operational states may be controlled.

For clarity, FIG. 5 encompasses a sub-set of the system components shown in FIG. 2, but may be easily expanded by anyone skilled in the art to include additional roadway marking equipment system components as shown in FIGS. 2A, 2B and 2C. Power controller 700 comprises vehicle battery 701 having the negative terminal connected to chassis ground and the positive terminal connected to one terminal of conventional fuse 703. Fuse 703 is provided for circuit overcurrent protection.

The other terminal of fuse 703 connects to one terminal of SPST main power switch 702. The other terminal of switch 702 connects to line 720 and to one switching contact 706 of power relay 705. The other switching contact 707 of relay 705 connects to the power input terminal of +12 VDC switching regulator 710 via line 712. Other switching regulators and/or electrical loads may be connected in parallel with switching regulator 710 via line 713. For example, a +24 VDC switching regulator 714 may be connected in parallel with switching regulator 710 via line 713 to provide +24 VDC power to the electric motor 414 via line 727. Line 781 connects to one terminal of pull-down resistor 729, and the other terminal of resistor 729 is grounded. Resistor 729 maintains line 781 at a logic 0 state for those times that the microcontroller 395 pin is in a high impedance state. Line 781 controls the power on-off state of switching regulator 710 thereby controlling power to motor 414. Line 781 connects to an output of either state machine 500 or 600.

The power output of switching regulator 710 is connected to line 722 which further connects to the positive power input + of transceiver 180 and the positive terminal + of current monitor 724. The negative terminal − of current monitor connects to the positive power input terminal of computer 342 via line 734. The current monitor 724 measures the power current flow to the computer 342 and provides an analog signal onto line 726 indicating the magnitude of computer 342 current. The signal placed onto line 726 may be used to indicate if computer 342 has completely shut-down or is still operating. Line 726 is connected to an analog to digital (A/D) input pin of microcontroller 395 as previously noted.

Computer 342 further has a control input IGN connected to line 783. Connected to line 783 is the output of voltage translation circuit 730. The input to voltage translation circuit is connected to line 731. One terminal of pull-down resistor 732 is connected to line 731 with the other terminal of resistor 732 connected to ground. The purpose of translation circuit 730 is to translate the +5 VDC nominal output voltage placed onto line 731 to +12 VDC as required by the control input IGN of computer 342. Line 731 connects to an output of either state machine 500 or 600.

Line 720 further connects to one terminal of the relay coil 750 and the cathode of fly-back diode 755. The other terminal of the relay coil 750 connects to the anode of diode 755 and to the drain of conventional n-channel enhancement MOSFET switching transistor 760. The source of transistor 760 is connected to ground. The gate of transistor 760 is connected to one terminal of pull-down resistor 762 and also to line 763. Placing a voltage of sufficient magnitude onto line 763 turns on transistor 760 which subsequently energizes coil 750 and closes the contacts 706 and 707 of relay 705. The other end of resistor 762 is connected to ground. Line 763 connects to an output of either state machine 500 or 600.

Line 720 further connects to the terminal +V1 of linear voltage regulator 765 and to one terminal of SPST switch 767. The other terminal of switch 767 connects to line 721 and to the +V2 terminal of regulator 765. Line 721 also connects to voltage monitor 770. Voltage monitor 770 outputs a digital signal onto line 771 which gives an indication of the state of switch 767, i.e., whether switch 767 is open or closed. Line 771 is connected to an input pin of microcontroller 395.

An example of the voltage regulator 765 is part number TLE4267 manufactured by Infineon Technologies AG of Germany. This low drop voltage regulator supplies a regulated +5 VDC output voltage and is specifically manufactured for the vehicle market.

Regulator 765 further has a REG input connected to line 773 and to one terminal of pull-up resistor 772. The other terminal of resistor 772 connects to the +VCC power bus. Once the regulator 765 is initially turned on by a closure of switch 767 (which applies power to terminal +V2), the regulator can be maintained in its on state with the REG input low irrespective of the switch 767 state (switch 767 can be on or off) and regulator 765 will still supply +VCC (+5 VDC) power. After power has been applied to regulator 765 via switch 767, the REG input should be held low to maintain +VCC power. If REG input is pulled-up to +VCC after being initially held low, regulator 765 will turn off and will not provide +VCC bus power. Line 773 connects to an output of either state machine 500 or 600.

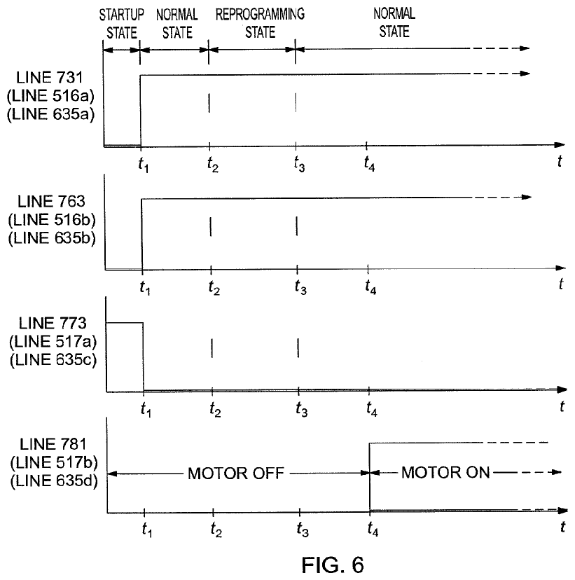

Referring additionally to FIG. 6, three operational states of controller 700 are shown and include the start-up operational state (0≤t≤t1), the normal operational state for time periods (t1≤t≤t2) and t≥t3, and the reprogramming of the computer 342 and the microcontroller 395 operational state (t2≤t≤t3). Also shown is an example of a signal placed onto line 781 controlling the motor 414 power at t=t4.

The start-up operational state for the power controller 700 is defined for 0·t≤t1 having lines 731, 763 and 781 at a logic 0 state and line 773 at a logic 1 state. The start-up operational state includes the time for microcontroller 395 to complete both its POR procedure and execution of the bootloader program. The start-up state operational state may be programmed by the SPDT switches which set the pull-down or pull-up states for the respective resistors as previously discussed with reference to FIG. 3B.

With line 731 having a logic 0 signal, the IGN input of computer 342 is at a logic 0 state and computer 342 is disabled.

With line 763 having a logic 0 signal, transistor 760 is off and relay coil 750 is not energized. Hence contacts 706 and 707 are open and voltage VBATT is not applied to lines 712 and 713. Hence the computer 342 and transceiver 180 are not powered.

With line 773 having a logic 1 signal, regulator 765 is enabled and supplies +VCC bus voltage.

With line 781 having a logic 0 signal and no power on line 713 (contacts 706 and 707 are open), motor 414 is not powered.

The normal operational state for the power controller 700 is defined for t1≤t≤t2 and t≥t3. For this state a logic 1 signal placed onto lines 731 and 763 and a logic 0 signal placed onto line 773 and 781 for the presented example, although these logic signal values may be changed by microcontroller 395 according to the desired operational state of the power controller 700. With this normal operational state, power is applied to both the computer 342 and the microcontroller 395.

With line 731 having a logic 1 signal, the IGN input of computer 342 is at a logic 1 state and computer 342 is enabled.

With line 763 having a logic 1 signal, transistor 760 is on and relay coil 750 is energized. Hence contacts 706 and 707 are closed and voltage VBATT is applied to lines 712 and 713 thereby supplying power to the transceiver 180, computer 342 and voltage translation circuit 730.

With line 773 having a logic 0 signal, regulator 765 is enabled and supplies +VCC voltage irrespective of the voltage on terminal +V2. Subsequently placing a logic 1 signal onto line 773 will shut off regulator 765.

With line 781 having a logic 0 signal, the +24 VDC switching inverter is disabled and no power is applied to motor 414.

The reprogramming of the computer 342 and microcontroller 395 operational state is defined, for example, in the period t2≤t≤t3. It is assumed that the normal operational power state for power controller 700 should be maintained, i.e., lines 731, 763 should be at logic 1 state and lines 773 and 781 should be at logic 0 state. Afterwards for t≥t3, these operational states are maintained unless subsequently changed by the application program of microcontroller 395. For example, at t=t4 the microcontroller 395 via either the state machine 500 or 600 (or combination) supplies power to motor 414 via a logic 1 signal placed onto line 781.

The power controller system 700 may be controlled by a state machine 500 only implementation, a state machine 600 only implementation or a combination of both implementations. Note that the operational state of controller 500 is maintained through the reprogramming time period t2 through t3.

For the state machine 500 implementation, lines 516a, 516b, 517a and 517b are connected to lines 731, 763, 773 and 781 respectively, i.e., lines 516a, 516b, 517a and 517b are mapped to lines 731, 763, 773 and 781 respectively. The start-up operational states for lines 731, 763, 773 and 781 are determined by having resistors 506a, 506b and 511b configured as pull-down resistors and resistors 511a configured as pull-up resistor. These resistor configurations define the start-up operational logic states of the lines 731, 763, 773 and 781 for times 0≤t≤t1 as shown in FIG. 6.

For the state machine 600 implementation, lines 635a, 635b, 635c and 635d are connected to lines to 731, 763, 773 and 781 respectively, i.e., lines 635a, 635b, 635c and 635d are mapped to lines 731, 763, 773 and 781 respectively. The start-up operational states for lines 731, 763, 773 and 781 are determined by having resistors 618a, 618b and 618d configured as pull-down resistors and resistor 618c configured as a pull-up resistor. These resistor configurations define the start-up operational logic states of the lines 731, 763, 773 and 781 for times 0≤t≤t1 as shown in FIG. 6.

For the state machines 500 and 600 combinational implementation, lines 516a, 516b and 517b may be connected to lines 731, 763 and 781 respectively and line 635c may be connected to line 773, although other combinations are possible. In the following discussion, only the individual implementations are discussed, although someone skilled in the art will be able to combine both state machine 500 and state 600 implementations.

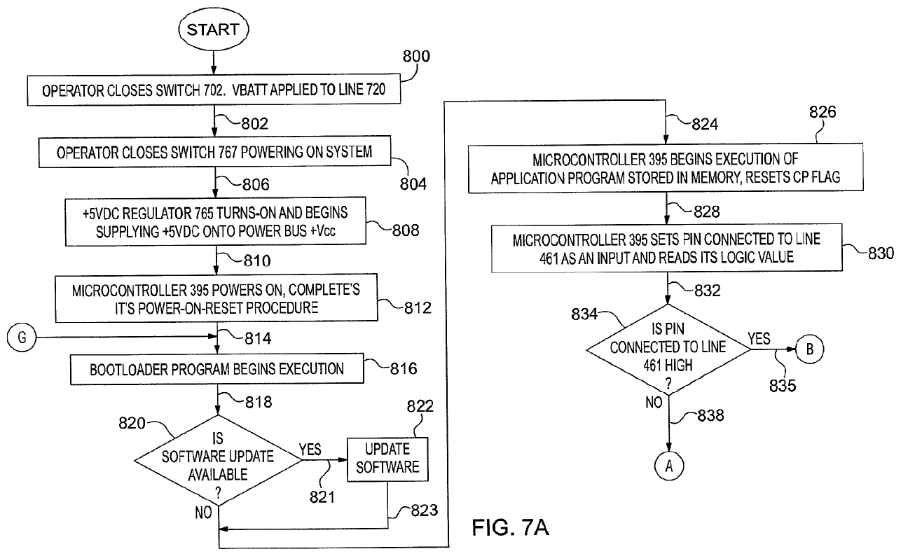

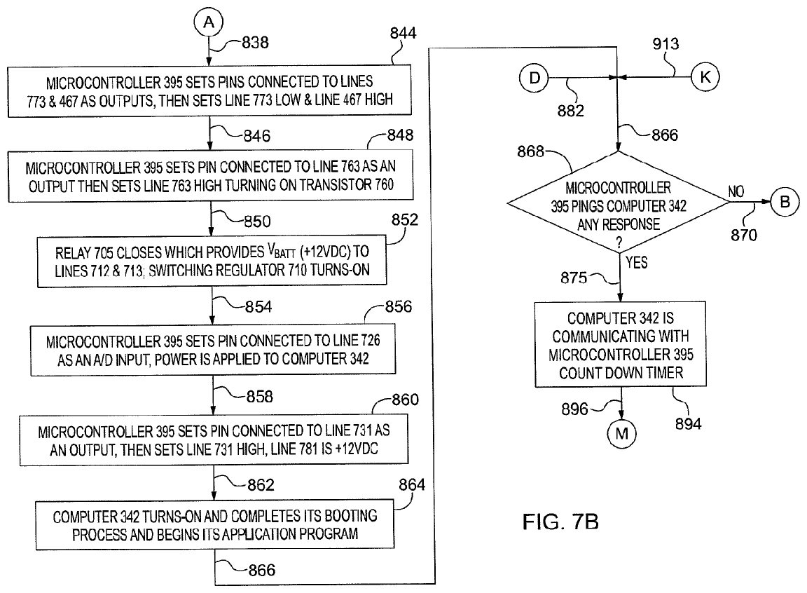

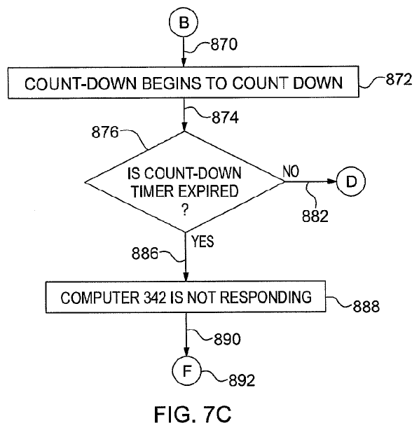

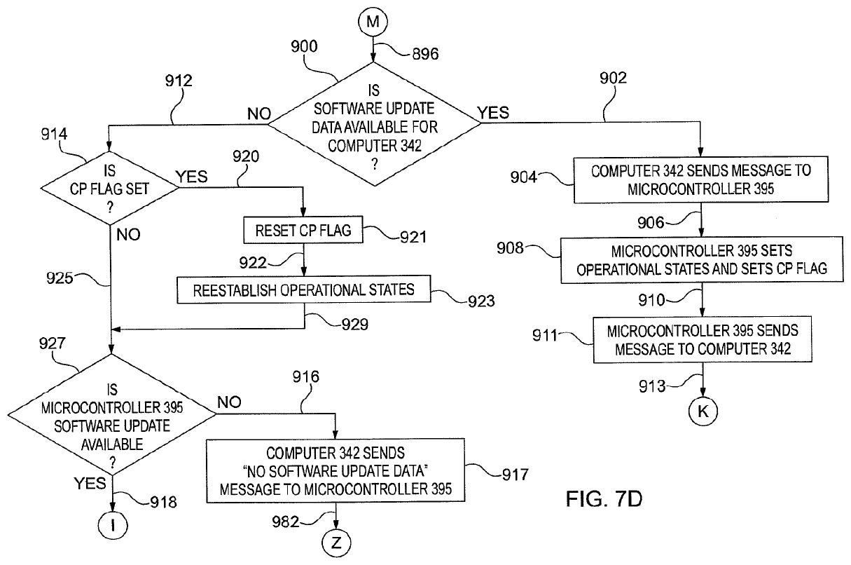

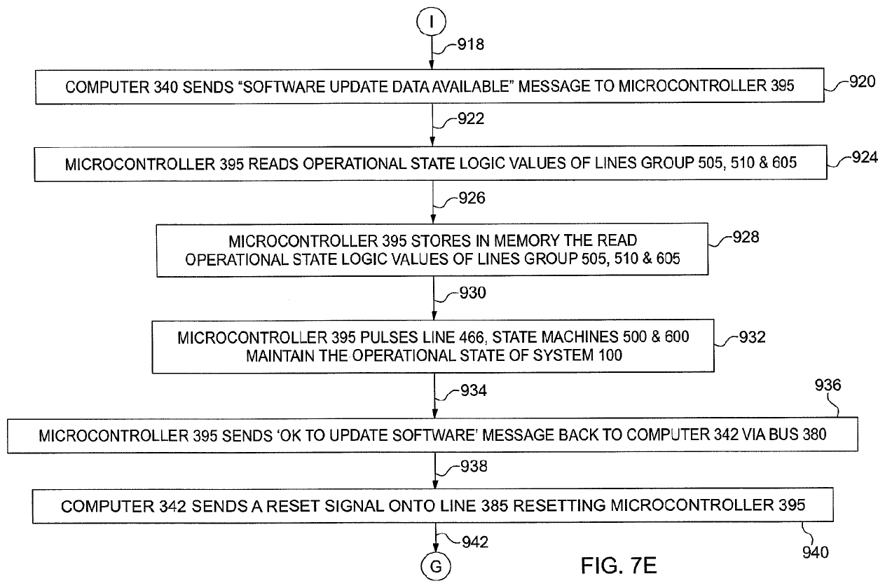

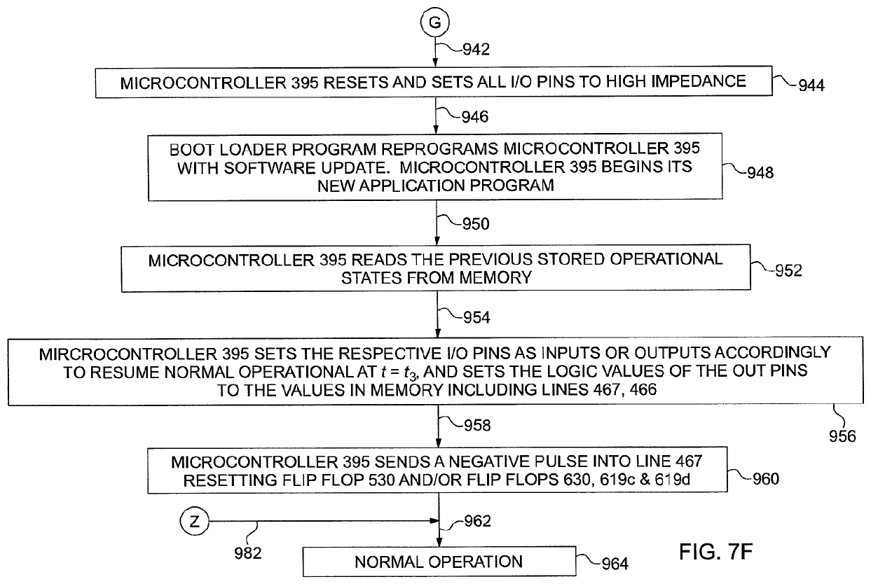

In operation and referring additionally to FIGS. 7A, 7B, 7C, 7D, 7E and 7F the operator enables system 700 in step 800 by closing SPST main power switch 702 which supplies battery voltage VBATT onto line 720. Operational flow is then transferred via line 802 to step 804.

In step 804, the operator closes switch 767 which provides the VBATT voltage onto line 721 and terminal +V2 of regulator 765 and voltage monitor 770. In response to switch 767 closure, voltage monitor 770 outputs a logic 1 signal (typically a voltage of +5 VDC) onto line 771 which connects to an input pin on microcontroller 395 indicating that switch 767 is closed. Operational flow is then transferred via line 806 to step 808.

In step 808 and in response to the voltage on terminal +V2, regulator 765 begins to supply +5 VDC onto power bus +VCC to the entire system including the AND gates, OR gates and flip-flops of FIGS. 3 and 4, microcontroller 385 (and microcontroller 397 if so equipped) and other circuits. Further the REG input of regulator 765 is held at +VCC by pull-up resistor 772.

Referring specifically to FIG. 3 (state machine 500 implementation) and having +VCC just applied, the microcontroller pin connected to line 467 is in high impedance but line 467 is held at +5 VDC because of pull-up resistor 570. Additionally, capacitor 585 initially maintains line 575 low which sets the output of AND gate 590 low placing a logic 0 signal onto line 560 which then resets flip-flop 530 which in turn sets its Q low placing a logic 0 signal onto line 550 and sets its Q-bar high placing a logic 1 signal onto line 555. With capacitor 585 charging the voltage on line 575 will eventually place a logic 1 signal on the corresponding input of AND gate 590. Both inputs of AND gate 590 are now at a logic 1 state setting line 560 to a logic 1 state. Flip-flop 530 is now reset having its Q set to logic 0 and its Q-bar set to logic 1 state.

With lines 505a and 505b at a logic 0 state (as the result of resistors 506a and 506b being configured as pull-down resistors) and having lines 525a and 525b at a logic 0 state (as the result of flip-flop 530 being reset), lines 516a and 516b are at a logic 0 state. With line 510a at a logic 1 state (as the result of resistor 511a being configured as a pull-up resistor) and line 530a at a logic 1 state (as the result of flip-flop 530 being reset) line 517a is at a logic 1 state. With line 510b at a logic 0 state (as the result of resistor 511b being configured as a pull-down resistor) line 517b is at a logic 0 state. These start-up operational logic states are shown in FIG. 6.

It is therefore understood that the outputs 516a, 516b, 517a and 517b have been configured to have predefined output logic states during the start-up operational state of power controller 700 by configuring (programming the state of) resistors 506a, 506b and 511b as pull-down resistors and resistor 511a as a pull-up resistor. The output logic states of outputs 516a, 516b, 517a and 517b will be maintained at the start-up states unless subsequently changed by the microcontroller 395 via its application program (or after receiving commands from computer 342 via bus 385).

Referring specifically to FIG. 4 (state machine 600 implementation) and having +VCC just applied, the microcontroller pin connected to line 467 is in high impedance but line 467 is held at +5 VDC because of pull-up resistor 670. During this time, capacitor 685 initially maintains line 687 low which sets the output of AND gate 690 low placing a logic 0 signal onto line 660. A logic 0 signal on line 660 resets flip-flop 630 which in turn sets its Q low placing a logic 0 signal onto line 650 (and line 461) and sets its Q-bar high placing a logic 1 signal onto line 655. With capacitor 685 fully charged, the output of AND gate 690 is high placing a logic 1 signal onto line 660. Flip-flop 630 is now cleared having Q set to logic 0 state and Q-bar set to logic 1 state.

Additionally, a logic 0 signal on line 660 resets flip-flops 619a, 619b, 619c and 619d which in turn sets a logic 0 signal onto lines 620a, 620b, 620c and 620d respectively, and forces the outputs of the AND gates 625b, 625d, 627b and 627d to logic 0 state.

A logic 1 on line 655 enables the AND gates 625a, 625c, 627a and 627c to pass through the logic state established on the lines 617a, 617b, 617c and 617d respectively to the output lines 631a, 631c, 633a and 633c respectively, which further connect to the inputs of their respective OR gate 629a, 629b, 629c and 629d. The other lines 631b, 631d, 633b and 633d are set to a logic 0 state as the result of line 650 set to a logic 0 state.

During the start-up period, having resistors 618a, 618b and 618d configured (programmed) as pull-down resistors sets a logic 0 signal onto lines 635a, 635b and 635d respectively, and having resistor 618c configured (programmed) as a pull-up resistor sets a logic 1 signal onto line 635c.

It is therefore understood that the outputs 635a, 635b, 635c and 635d have been configured (programmed) to have predefined output logic states during the start-up operational state of power controller 700 by configuring resistors 618a, 618b and 618d as pull-down resistors and resistor 618c as a pull-up resistor. The output logic states of outputs 635a, 635b, 635c and 635d will be maintained at these start-up states unless subsequently changed by the microcontroller 395 via its application program (or receiving commands from computer 342 via bus 385).

Operational flow is then transferred via line 810 to step 812.

In step 812, microcontroller 395 begins and then completes its power-on-reset (POR) procedure in response to the just applied +VCC voltage. During the POR state, all I/O pins of microcontroller 395 are set to high impedance. During this period, the I/O pins are configured as high impedance inputs and remain in this high impedance state until changed by the application program. Program control is then transferred to the bootloader program. Operational flow is then transferred via line 814 to step 816.

In step 816, the microcontroller 395 begins executing the resident bootloader program at its defined memory location. Operational flow is then transferred via line 818 to step 820.

In step 820, the bootloader program determines if software update data is available (for example, if software update data has been previously stored in memory 470 by the third software upgrading process). If a software update is not available, operational flow then continues via line 824 to step 826. If the bootloader program determines that software update data is available, operational flow continues via line 821 to step 822.

In step 822, the bootloader replaces the microcontroller 395 software with the new software update data by conventional means. Operational flow continues to step 826 via lines 823 and 824.

In step 826, microcontroller 395 begins to execute the application program currently stored in its memory and in addition resets (clears) a conventional flag labelled as “CP” (computer programmed). Operational flow continues to step 830 via line 828.

In step 830, microcontroller 395 sets the pin connected to line 461 as an input and reads its logic value. Operational flow is then transferred via line 832 to step 834.

In step 834, if line 461 has a logic 1 state, operational flow continues to step 872 (‘B’) via lines 835 and 870. If line 461 has a logic 1 state, the microcontroller 395 has been reprogrammed by computer 342. If line 461 has a logic 0 state, the microcontroller 395 has not been reprogrammed by computer 342 and operational flow is then transferred via line 838 to step 844 (‘A’).

In step 844, microcontroller 395 programs the I/O port pins through connected to lines 773 (for example, line 510a) and 467 as outputs and then sets line 773 equal to a logic 0 state thereby forcing the REG input of regulator 765 to a logic 0 state. With line 773 held low, regulator 765 maintains +VCC irrespective of the state of switch 767. Microcontroller 395 then also sets the pin connected to line 467 to a logic 1 state. Operational flow is then transferred via line 846 to step 848.

In step 848, the microcontroller 395 then programs the I/O port pin through connected to line 763 as an output and sets it equal to logic 1 state (+5 VDC) thereby turning on transistor 760 and energizing coil 750 of relay 705. Operational flow is then transferred via line 850 to step 852.

In step 852, a closed relay 705 provides VBATT (nominally +12 VDC) to lines 712 and 713. Energizing relay coil 750 closes switching contacts 706 and 707 of relay 705 and supplies battery voltage VBATT to switching regulator 710 via line 712 and any other regulators or loads connected to line 713, such as regulator 714. Operational flow is then transferred via line 854 to step 856.

In step 856, microcontroller 395 programs the I/O port pin connected to line 726 as an A/D input pin and switching regulator 710 powers-on and supplies regulated +12 VDC power to the transceiver 180 and current monitor 724, which in turn supplies power to computer 342 via line 734. Current monitor 724 provides an analog signal onto line 726 indicating the magnitude of computer 342 current. Operational flow is then transferred via line 858 to step 860.

In step 860, microcontroller 395 then programs the I/O port pin through connected to line 731 as an output pin and sets the value equal to a logic 1 state. In response to a logic 1 state on line 731, voltage translation circuit 730 outputs +12 VDC onto line 782 which flows to the IGN input of computer 342. Operational flow is then transferred via line 862 to step 864.

In step 864, computer 342 powers on begins and completes its booting process in response to the +12 VDC signal on its IGN input and applied power via line 734 and begins executing its application program. Microcontroller 395 sets a count-down timer. Operational flow is then transferred via line 866 to step 868.

In step 868, microcontroller 395 pings computer 342 with a message placed onto bus 380. If no message is received back from the computer 342 to the microcontroller 395, operational flow is then transferred via line 870 (‘B’) to step 872. If the microcontroller 395 receives a message from computer 342 from bus 380 stating that the computer 342 is operational, operational flow is then transferred via line 875 to step 894.

In step 872, microcontroller 395 enables a software count-down timer. Operational flow is then transferred via line 874 to step 876.

In step 876, microcontroller 395 checks to see if the count-down timer has expired. If the count-down timer has not expired, operation flow continues back to step 868 via lines via 882 and 866. If the count-down timer has expired, operational flow is then transferred via line 886 to step 888.

In step 888, computer 342 is not able to respond to the microcontroller 395 initiated pings for a period of time determined by the count-down timer and operational flow is then transferred via line 890 to step 892 (‘F’). Here ‘F’ represents additional software to handle a non-responsive computer 342 and may include software to either shut-down completely or partially the roadway marking equipment system components.

In step 894, computer 342 is in bi-directional communication with microcontroller 395 via bus 380, and microcontroller sets the count-down timer. Operational flow is then transferred via line 896 to step 900.

In step 900, computer 342 checks if any software update data is available either from the server 497 which is connected to the internet (cloud 498) via communication channel 499 via transceiver 180, or which has been previously received via the internet and stored in computer 342. The software update data may be for computer 342 and/or microcontroller 395. Always the latest version of the software update data is used whether it is received immediately from the transceiver 180 from the internet or that which has been previously received and stored into the memory of computer 342. If software upgrade data is available for computer 342, operational flow is then transferred via line 902 to step 904. If software update data is not available for computer 342, operational flow is then transferred via line 912 to step 914.

In step 904, a message “software update data available for computer” is sent to microcontroller 395 via bus 380. Operational flow is then transferred via line 906 to step 908.

In step 908, microcontroller 395 sets the desired operational states of system 700 (or in general system 100) via the state machines 500 and/or 600 and sets a computer program (CP) flag. Operational flow is then transferred via line 910 to step 911.

In step 911, microcontroller 395 sends a message to computer 342 to begin reprogramming its memory. Operational flow is then transferred via lines 913 (“K”) and 866 to step 868.

In step 914, microcontroller 395 checks the status of the CP flag. If the CP flag is set, operational flow is transferred via line 920 to step 921.

In step 921, microcontroller 395 resets the CP flag. Operational flow is then transferred via line 922 to step 923.

In step 923, microcontroller 395 reestablishes the pre-computer-programming operational states of system 700 (or in general system 100). Operational flow is then transferred via lines 929 and 925 to step 927.

In step 927, computer 342 checks if microcontroller 395 software update data is available. If software update data is not available, operational flow is transferred via line 916 to step 917. If software update data is available, operational flow is transferred via line 918 (“I”) to step 920.

In step 917, computer 342 sends a “no software update available” to microcontroller 395. Operational flow is transferred via lines 982 (“Z”) and 962 to step 964.

In step 920, computer 342 sends a “software update available” message to microcontroller 395 via bus 380. Operational flow then transferred via line 922 to step 924.

In step 924, microcontroller 395 in response to the “software update data available” message reads the logical states of the line groups 505, 510 and 605. Operational flow is then transferred via line 926 to step 928.

In step 928, microcontroller 395 stores the logical states of the lines 505a, 505b, 511a and 51 1b for the state machine 500 implementation or lines 617a, 617b, 617c and 617d for the state machine 600 implementation in memory 470 via bus 475 or internal memory of the microcontroller 395. Operational flow is then transferred via line 930 to step 932.

In step 932 and for the state machine 500 implementation, microcontroller 395 sends a pulse onto line 466 clocking flip-flop 530. Clocking flip-flop 530 sets line 550 to a logic 1 state (sets Q high) and places a logic 1 signal onto the input lines 525a and 525b of OR gate 515 which forces lines 516a and 516b to a logic 1 state. Clocking flip-flop 530 also sets line 555 to a logic 0 state (sets Q-bar low) and places a logic 0 signal onto the input lines 530a and 530b of AND gates 520a and 520b which forces line 517a and 517b to a logic 0 state.

The normal operational state of the line groups 515 and 517 are therefore maintained after flip-flop 530 is clocked irrespective of further changes to the logic states of line group 505 and 510. These normal operational states are subsequently held by the state machine during reprogramming of microcontroller 395.

In step 932 and for the state machine 600 implementation, microcontroller 395 sends a pulse onto line 466 clocking flip-flops 630, 619a, 619b, 619c and 619d. Clocking flip-flop 630 sets line 650 to a logic 1 state (sets Q high) and places a logic 1 signal onto one of the inputs of AND gates 625b, 625d, 627b and 627d. Clocking flip-flop 630 also sets line 655 to a logic 0 state (sets Q-bar low) and places a logic 0 signal onto the inputs of their respective AND gates 625a, 625c, 627a and 627c which forces all of the outputs of lines 631a, 631c, 633a and 633c to a logic 0 state.

Clocking flip-flop 619a sets the Q output on line 620a equal to the D input of line 617a. For example, if line 617a is low when the flip-flop 619a is clocked, output D is low, and if line 617a is high when the flip-flop 619a is clocked, output D is high. This is repeated for flip-flops 619b, 619c and 619d for this example. The logic state of the clocked Q outputs of flip-flops 619a, 619b, 619c and 619d are gated through their respective AND gates. For example, if line 617b is set to a logic 1 state, Q on line 620b will be set to a logic 1 state and will be gated through AND gate 625d setting line 631d to a logic 1 state which sets the output line 635b of OR gate 629b high.

The normal operational state of the line group 605 are therefore maintained after flip-flop 630 is clocked irrespective of further changes to the logic states of line group 605. These normal operational states are subsequently held by the state machine during reprogramming of microcontroller 395.

Operational flow is then transferred via line 934 to step 936.

In step 936, microcontroller 395 having clocked flip-flop 530 and/or flip-flop 630, sends a “OK to reprogram” signal onto bus 380 back to computer 342. Operational flow is then transferred via line 938 to step 940.

In step 940 and in response to receiving the “OK to reprogram” signal from microcontroller 395, computer 342 pulses line 385 low (logic 0 state) which resets microcontroller 395. Operational flow is then transferred via line 942 (‘G’) to step 944.

In step 944 and in response to a logic 0 signal on line 385, microcontroller 395 resets and subsequently sets all I/O pins to high-impedance and begins to execute the bootloader program. State machines 500 and 600 maintain the operational state of the system 700.

Maintaining line 731 high maintains computer 342 in an on-state (the IGN input remains at +12 VDC) and computer 342 is therefore able to transmit the software update data to the microcontroller 395 via bus 380.

Maintaining line 763 high during the reprogramming of microcontroller 395 maintains power to relay 705 via transistor 760, and subsequently maintains battery power on line 712 and line 713. The switching regulator 710 therefore continues to provide uninterruptable power to transceiver 180, computer 342 and voltage translation circuit 730.

Maintaining line 773 low during reprogramming of microcontroller 395 maintains +VCC at +5 VDC.

For the state machine 500 implementation, lines 731 and 763 are connected to lines 516a and 516b respectively (having resistors 506a and 506b configured as pull-down resistors respectively) and line 773 is connected to line 517a (having resistor 511a configured as a pull-up resistor). Line 517b is connected to line 781 having resistor 511b configured as a pull-down resistor.

For the state machine 600 implementation, lines 731 and 763 are connected to lines 635a and 635b respectively (having resistors 618a and 618b configured as pull-down resistors respectively) and line 773 is connected to line 635c (having resistor 618c configured as a pull-up resistor). Line 635d is connected to line 781 having resistor 618d configured as a pull-down resistor.

Thus, the operational states of system 700 is maintained during the start-up, the normal operation and the computer 342 and microcontroller 395 reprogramming times.

Operational flow is then transferred via line 946 to step 948.

In step 948, the bootloader program of microcontroller 395 reprograms the program memory of the microcontroller 395 with the software update data. The program update data can be directly obtained from memory 470 if previously stored by the uploader program, or can be directly obtained from computer 342 via bus 380. In either case, the program memory has been updated. The bootloader program then directs the microcontroller 395 to begin execution at the beginning of the new updated software program. Operational flow is then transferred via line 950 to step 952.

In step 952, microcontroller 395 reads the previously saved operational output states from memory 470. Operational flow is then transferred via line 954 to step 956.

In step 956, microcontroller 395 establishes the I/O states of the respective pins and sets all line group 505 and 510 for state machine 500, and/or line group 617 for state machine 600 to their respective saved memory 470 values. Further, those pins which were previously programmed as input pins are now reprogrammed as input pins. The operational states just before reprogramming of microcontroller 395 occurred are now reestablished. Operational flow is then transferred via line 958 to step 960.

In step 960, microcontroller 395 sends a negative pulse onto line 467 which resets flip-flop 530 and/or flip-flop 630. Operational flow is then transferred via line 962 to step 964.

In step 964, the system 700 continues with normal operation.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

We claim:

1. A field programmable controller for controlling components of roadway marking equipment mounted on a vehicle, the field programmable controller comprising:
a wireless transceiver configured to communicate with a network and request and receive software update data;
a computer, having computer memory, in wired or wireless communication with the wireless transceiver and the components of the roadway marking equipment, and configured to:
(a) receive the software update data from the wireless transceiver and store the software update data,
(b) communicate the software update data,
(c) receive component data from the components of the roadway marking equipment and based on the component data received, communicate instructions for performing roadway marking tasks, stored in the computer memory, to the components of the roadway marking equipment;
a microcontroller, having program memory, in wired or wireless communication with the computer, and configured to:
(a) control the operational state of the components of the roadway marking equipment during performance of roadway marking tasks,
(b) receive and store software update data from the computer, and
(c) update the computer memory or program memory with the software update data; and
a state machine, in wired or wireless communication with the microcontroller, the state machine being configured to:
(a) define and control the start-up operational state of the components of the roadway marking equipment,
(b) maintain a operational state of the components of the roadway marking equipment during the times the computer memory or program memory are being updated with software update data, and
(c) maintain the operational state of the components of the roadway marking equipment during normal operation.

2. The field programmable controller of claim 1, wherein, upon the startup of the vehicle, the computer automatically compares the software update data available on the network with the software update data stored in the computer memory and program memory and determines if there is a difference.

3. The field programmable controller of claim 2, wherein, when the software update data available on the network are different from the software update data stored in the computer memory or program memory and the computer transmits the software update data available on the network to the microcontroller.

4. The field programmable controller of claim 3, wherein the microcontroller updates the computer memory or program memory with the software update data available on the network.

5. The field programmable controller of claim 1, wherein the computer is configured to compare at the direction of an operator, the software update data available on the network with the software update data stored in the computer memory and program memory and determine if there is a difference.

6. The field programmable controller of claim 5, wherein, when the software update data available on the network is different from the software update data stored in the computer memory or program memory and the computer transmits the software update data available on the network to the microcontroller.

7. The field programmable controller of claim 6, wherein the microcontroller updates the computer memory or program memory with the software update data available on the network.

8. The field programmable controller of claim 1, wherein, at a specified interval the computer automatically compares the software update data available on the network with the software update data stored in the computer memory and program memory and determines if there is a difference.

9. The field programmable controller of claim 8, wherein, when the software update data available on the network is different from the software update data stored in the computer memory or program memory and the computer transmits the software update data available on the network to the microcontroller.

10. The field programmable controller of claim 9, wherein the microcontroller updates the computer memory or program memory with the software update data available on the network.

11. The field programmable controller of claim 8, wherein the specified interval is continuous.

12. The field programmable controller of claim 1, wherein the computer does not power down when the computer memory or program memory is updated.

13. The field programmable controller of claim 1, wherein an update to the computer memory changes the instructions for performing roadway marking tasks in relation to the component data received.

14. The field programmable controller of claim 1, wherein the state machine further comprises pull-down resistors or pull-up resistors, OR gates, AND gates, a Q-bar output, and a flip-flop.

15. The field programmable controller of claim 14, wherein the combined number of pull-down resistors and pull-up resistors in the state machine is at least four.

16. The field programmable controller of claim 1, wherein the state machine includes a field programmable gate array or a complex programmable logic device.

17. The field programmable controller of claim 1, further comprising an input to a voltage translation circuit connected to an output of the state machine.

18. A system for updating software for controlling components of roadway marking equipment mounted on a vehicle in the field, the system comprising:
a wireless transceiver in communication with: a network and a computer having computer memory on which a stored version of software for controlling components of the roadway marking equipment resides, the computer being in communication with a microcontroller having program memory on which the stored version of the software for controlling components of the roadway marking equipment resides, the microcontroller being in communication with a state machine;
wherein, the computer, through the wireless transceiver, requests and receives an online version of software for controlling components of the roadway, from the network,
wherein, the computer compares the stored version of the software to the online version of the software and upon the determination of a difference between the online version and the stored version the computer updates the program memory with the online version of the software and then the microcontroller updates the computer memory with the online version of the software, and
wherein during the update the state machine maintains an operational state of the components of the roadway marking equipment and the components of the roadway marking equipment.
